(19) United States
(12) Patent Application Publication
(10) Pub. No.: US 2024/0380755 A1
(43) Pub. Date: Nov. 14, 2024

(54) ACCOUNT REGISTRATION PROCESSING METHODS AND APPARATUSES

(71) Applicant: Alipay (Hangzhou) Information Technology Co., Ltd., Hangzhou (CN)

(72) Inventors: Xiaocheng GUO, Hangzhou (CN); Mingyu JIANG, Hangzhou (CN); Ruirui YU, Hangzhou (CN); Yue YE, Hangzhou (CN); Zhiqiang SUN, Hangzhou (CN); Shiwei HE, Hangzhou (CN); Xue REN, Hangzhou (CN)

(21) Appl. No.: 18/563,217

(22) PCT Filed: May 7, 2022
(86) PCT No.: PCT/CN2022/091543

§ 371 Date: Nov. 21, 2023

(30) Foreign Application Priority Data
May 21, 2021 (CN) 202110556719.3

(51) Int. Cl. H04L 9/40

(52) U.S. Cl. CPC H04L 63/102

(57) ABSTRACT

Embodiments of this specification provide account registration processing methods and apparatuses. The account registration processing method includes following: A contact method of a target user submitted by a first terminal is received, and an information collection page is returned to the first terminal; an invitation list is generated based on registration information entered based on the information collection page and submitted by the first terminal, and an invitation link generated based on the invitation list is sent to a second terminal based on the contact method; a display configuration parameter of the target user is determined based on the registration information after the invitation link is triggered; and account registration is performed based on the registration information and a registration result is sent to the first terminal if a registration confirmation instruction submitted after the second terminal displays information based on the display configuration parameter is received.

### TECHNICAL FIELD

This specification relates to the field of data processing technologies, and in particular, to account registration processing methods and apparatuses.

### BACKGROUND

With the rapid development of the information technology and Internet technology, online services are widely used, and the Internet brings great convenience to users' lives and work. Users can utilize the Internet to shop online, access entertainment, and perform various tasks. Generally, when performing services online, the user needs to register an account on a corresponding application client or website. In a registration process, the user needs to input verification information such as a mobile number and a message verification code. To ensure that the user who registers an account is a secure and effective user, information management in the user registration process is of great significance.

### SUMMARY

One or more embodiments of this specification provide a first account registration processing method. The account registration processing method is applied to a server and includes following: A contact method of a target user submitted by a first terminal is received, and an information collection page is returned to the first terminal; an invitation list is generated based on registration information entered based on the information collection page and submitted by the first terminal, and an invitation link generated based on the invitation list is sent to a second terminal based on the contact method; a display configuration parameter of the target user is determined based on the registration information after the invitation link is triggered; and account registration is performed based on the registration information and a registration result is sent to the first terminal if a registration confirmation instruction submitted after the second terminal displays information based on the display configuration parameter is received.

One or more embodiments of this specification provide a second account registration processing method, which is applied to a first terminal and includes following: A contact method of a target user is submitted to a server by using an initial page, and an information collection page returned by the server is received; registration information of the target user is entered by using the information collection page, and the registration information is submitted to the server; and a registration result returned after the server performs registration processing based on the registration information is received.

One or more embodiments of this specification provide a third account registration processing method, which is applied to a second terminal and includes following: An invitation link sent by a server is received; a registration confirmation page generated based on display configuration information and registration information of a target user submitted by an initiating user is displayed after the invitation link is triggered; and a registration confirmation instruction is submitted to the server after a registration confirmation control configured on the registration confirmation page is triggered.

One or more embodiments of this specification provide a first account registration processing apparatus, which runs on a server and includes: a contact method receiving module, configured to receive a contact method of a target user submitted by a first terminal, and return an information collection page to the first terminal; an invitation list generation module, configured to generate an invitation list based on registration information entered based on the information collection page and submitted by the first terminal, and send, based on the contact method, an invitation link generated based on the invitation list to a second terminal; a parameter determining module, configured to determine a display configuration parameter of the target user based on the registration information after the invitation link is triggered; and an account registration module, configured to perform account registration based on the registration information and send a registration result to the first terminal if a registration confirmation instruction submitted after the second terminal displays information based on the display configuration parameter is received.

One or more embodiments of this specification provide a second account registration processing apparatus, which runs on a first terminal and includes: a contact method submission module, configured to submit a contact method of a target user to a server by using an initial page, and receive an information collection page returned by the server; a registration information submission module, configured to enter registration information of the target user by using the information collection page, and submit the registration information to the server; and a registration result receiving module, configured to receive a registration result returned after the server performs registration processing based on the registration information.

One or more embodiments of this specification provide a third account registration processing apparatus, which runs on a second terminal and includes: a receiving module, configured to receive an invitation link sent by a server; a display module, configured to display, after the invitation link is triggered, a registration confirmation page generated based on display configuration information and registration information of a target user submitted by an initiating user; and a submission module, configured to submit a registration confirmation instruction to the server after a registration confirmation control configured on the registration confirmation page is triggered.

One or more embodiments of this specification provide a first account registration processing device, which runs on a server and includes: a processor, and a memory configured to store computer-executable instructions. When the computer-executable instructions are executed, the processor is enabled to: receive a contact method of a target user submitted by a first terminal, and return an information collection page to the first terminal; generate an invitation list based on registration information entered based on the information collection page and submitted by the first terminal, and send, based on the contact method, an invitation link generated based on the invitation list to a second terminal; determine a display configuration parameter of the target user based on the registration information after the invitation link is triggered; and perform account registration based on the registration information and send a registration result to the first terminal if a registration confirmation instruction submitted after the second terminal displays information based on the display configuration parameter is received.

One or more embodiments of this specification provide a second account registration processing device, which runs on a first terminal and includes: a processor, and a memory configured to store computer-executable instructions. When the computer-executable instructions are executed, the processor is enabled to: submit a contact method of a target user to a server by using an initial page, and receive an information collection page returned by the server; enter registration information of the target user by using the information collection page, and submit the registration information to the server; and receive a registration result returned after the server performs registration processing based on the registration information.

One or more embodiments of this specification provide a third account registration processing device, which runs on a second terminal and includes: a processor, and a memory configured to store computer-executable instructions. When the computer-executable instructions are executed, the processor is enabled to: receive an invitation link sent by a server; display, after the invitation link is triggered, a registration confirmation page generated based on display configuration information and registration information of a target user submitted by an initiating user; and submit a registration confirmation instruction to the server after a registration confirmation control configured on the registration confirmation page is triggered.

One or more embodiments of this specification provide a first storage medium, configured to store computer-executable instructions. When the computer-executable instructions are executed, the following procedure is implemented: receiving a contact method of a target user submitted by a first terminal, and returning an information collection page to the first terminal; generating an invitation list based on registration information entered based on the information collection page and submitted by the first terminal, and sending, based on the contact method, an invitation link generated based on the invitation list to a second terminal; determining a display configuration parameter of the target user based on the registration information after the invitation link is triggered; and performing account registration based on the registration information and sending a registration result to the first terminal if a registration confirmation instruction submitted after the second terminal displays information based on the display configuration parameter is received.

One or more embodiments of this specification provide a second storage medium, configured to store computer-executable instructions. When the computer-executable instructions are executed, the following procedure is implemented: submitting a contact method of a target user to a server by using an initial page, and receiving an information collection page returned by the server; entering registration information of the target user by using the information collection page, and submitting the registration information to the server; and receiving a registration result returned after the server performs registration processing based on the registration information.

One or more embodiments of this specification provide a third storage medium, configured to store computer-executable instructions. When the computer-executable instructions are executed, the following procedure is implemented: receiving an invitation link sent by a server; displaying, after the invitation link is triggered, a registration confirmation page generated based on display configuration information and registration information of a target user submitted by an initiating user; and submitting a registration confirmation instruction to the server after a registration confirmation control configured on the registration confirmation page is triggered.

### BRIEF DESCRIPTION OF DRAWINGS

To describe the technical solutions in one or more embodiments of this specification or in the existing technology more clearly, the following briefly introduces the accompanying drawings needed for describing the embodiments or the existing technology. Clearly, the accompanying drawings in the following description merely show some embodiments of this specification, and a person of ordinary skill in the art can still derive other drawings from these accompanying drawings without creative efforts.

FIG. 1 is a processing flowchart illustrating a first account registration processing method, according to one or more embodiments of this specification;

FIG. 2 is a schematic diagram illustrating a scenario of an account registration processing method, according to one or more embodiments of this specification;

FIG. 3 is a schematic diagram illustrating an initial page, according to one or more embodiments of this specification;

FIG. 4 is a schematic diagram illustrating an information collection page, according to one or more embodiments of this specification;

FIG. 5 is a schematic diagram illustrating a waiting reminder page, according to one or more embodiments of this specification;

FIG. 6 is a schematic diagram illustrating a registration confirmation page, according to one or more embodiments of this specification;

FIG. 7 is a processing flowchart illustrating a first invitation processing procedure, according to one or more embodiments of this specification;

FIG. 8 is a processing flowchart illustrating a first registration processing procedure, according to one or more embodiments of this specification;

FIG. 9 is a diagram illustrating a sequence of an account registration processing method applied to an invitation registration scenario, according to one or more embodiments of this specification;

FIG. 10 is a processing flowchart illustrating a second account registration processing method, according to one or more embodiments of this specification;

FIG. 11 is a processing flowchart illustrating a second invitation processing procedure, according to one or more embodiments of this specification;

FIG. 12 is a processing flowchart illustrating a third account registration processing method, according to one or more embodiments of this specification;

FIG. 13 is a processing flowchart illustrating a second registration processing procedure, according to one or more embodiments of this specification;

FIG. 14 is a schematic diagram illustrating a first account registration processing apparatus, according to one or more embodiments of this specification;

FIG. 15 is a schematic diagram illustrating a second account registration processing apparatus, according to one or more embodiments of this specification;

FIG. 16 is a schematic diagram illustrating a third account registration processing apparatus, according to one or more embodiments of this specification;

FIG. 17 is a schematic diagram illustrating a structure of a first account registration processing device, according to one or more embodiments of this specification;

FIG. 18 is a schematic diagram illustrating a structure of a second account registration processing device, according to one or more embodiments of this specification; and

FIG. 19 is a schematic diagram illustrating a third account registration processing device, according to one or more embodiments of this specification.

### DESCRIPTION OF EMBODIMENTS

To make a person skilled in the art understand the technical solutions in one or more embodiments of this specification better, the following clearly and comprehensively describes the technical solutions in the one or more embodiments of this specification with reference to the accompanying drawings in the one or more embodiments of this specification. Clearly, the described embodiments are merely some but not all of the embodiments of this specification. All other embodiments obtained by a person of ordinary skill in the art based on the one or more embodiments of this specification without creative efforts shall fall within the protection scope of this specification.

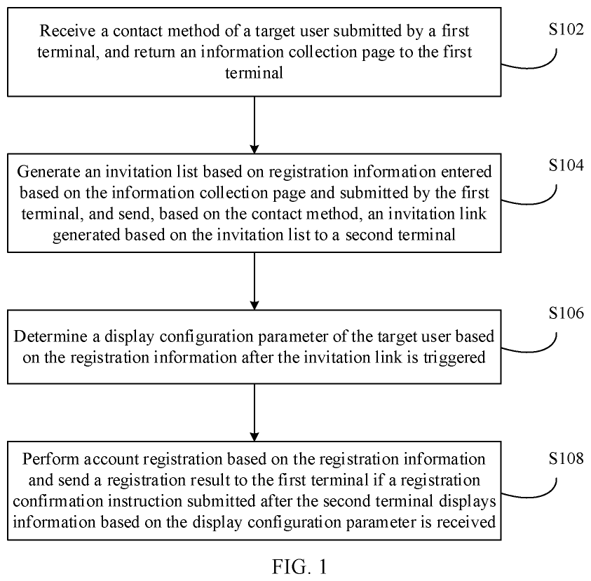

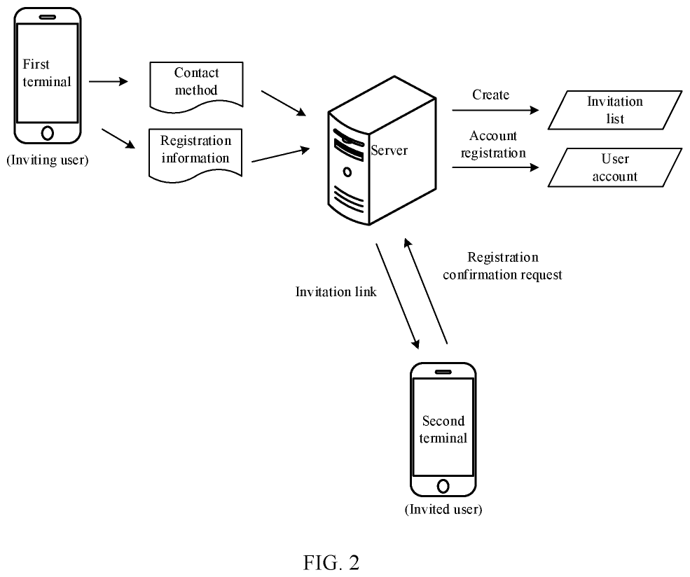

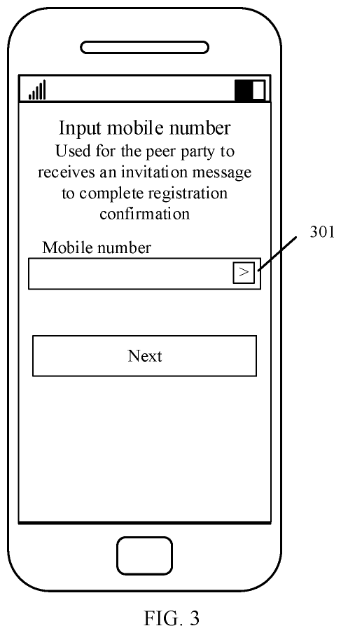

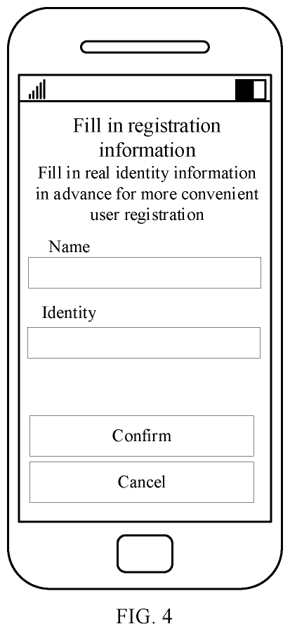

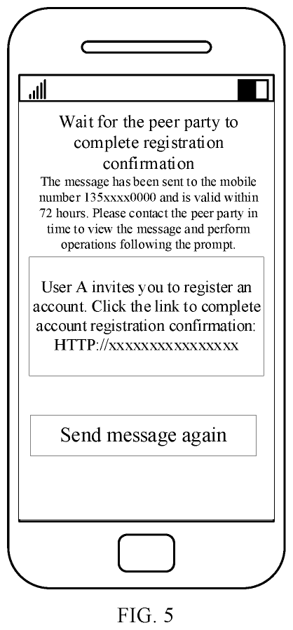

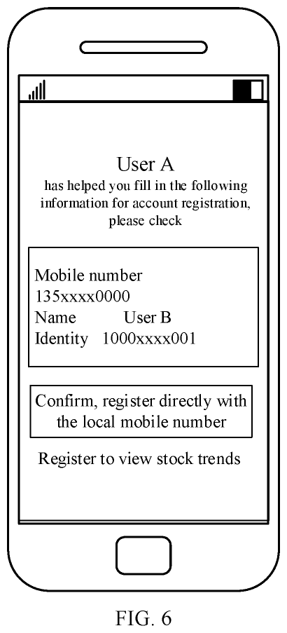

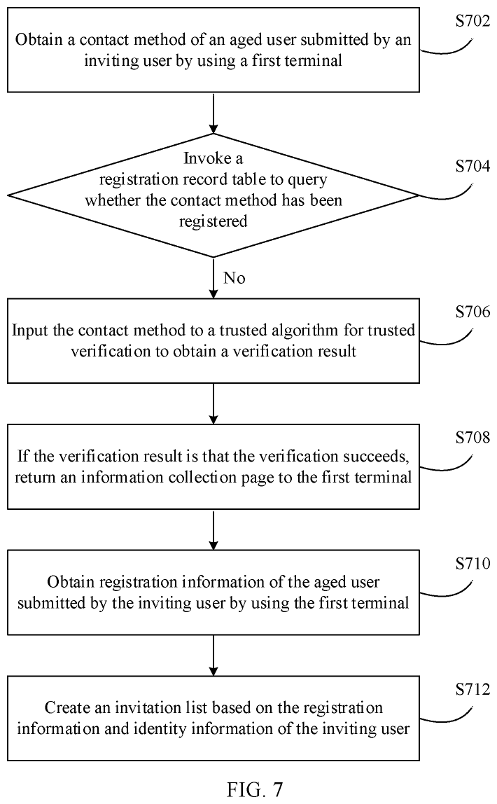

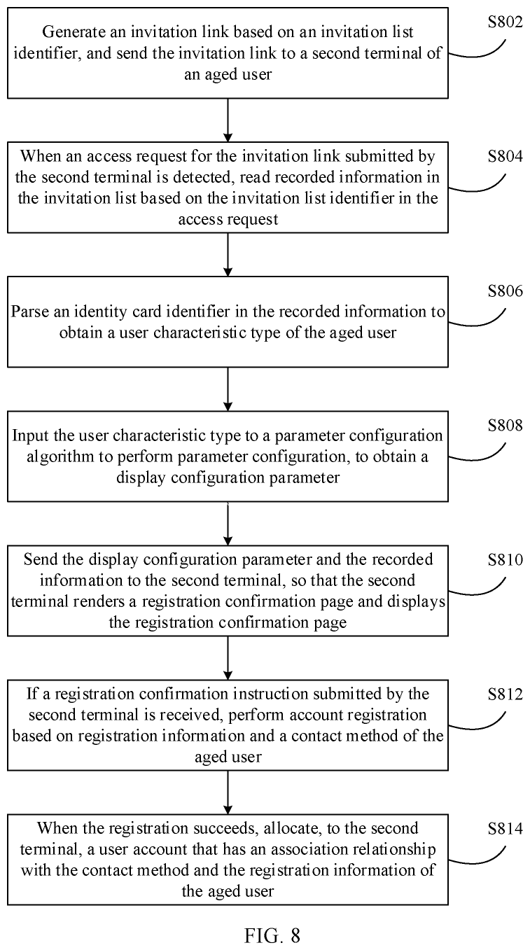

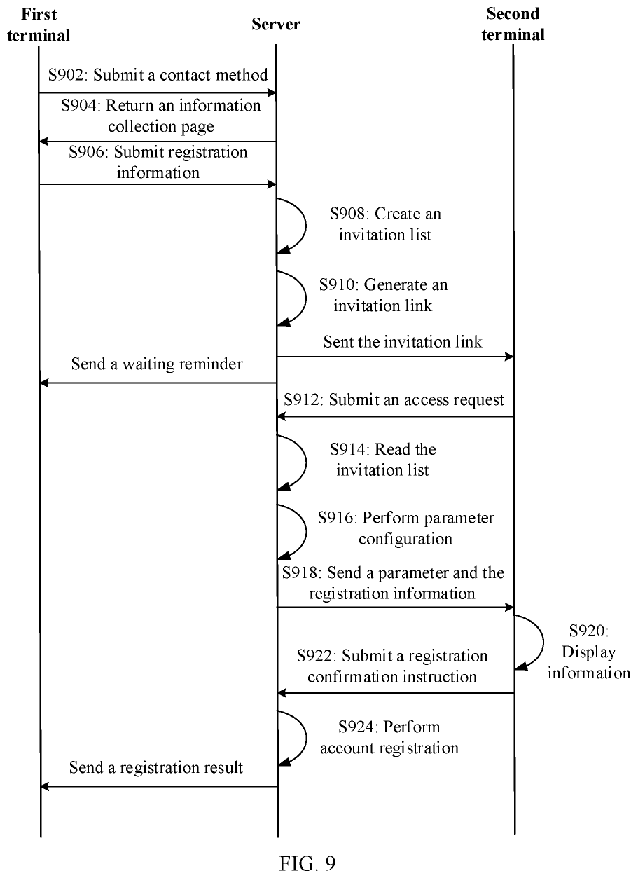

According to embodiments of a first account registration processing method provided in this specification, FIG. 1 is a processing flowchart illustrating an account registration processing method, according to one or more embodiments, FIG. 2 is a schematic diagram illustrating a scenario of an account registration processing method, according to one or more embodiments, FIG. 3 is a schematic diagram illustrating an initial page, according to one or more embodiments, FIG. 4 is a schematic diagram illustrating an information collection page, according to one or more embodiments, FIG. 5 is a schematic diagram illustrating a waiting reminder page according to one or more embodiments, FIG. 6 is a schematic diagram illustrating a registration confirmation page, according to one or more embodiments, FIG. 7 is a processing flowchart illustrating an invitation processing procedure, according to one or more embodiments, FIG. 8 is a processing flowchart illustrating a registration processing procedure, according to one or more embodiments, and FIG. 9 is a diagram illustrating a sequence of an account registration processing method applied to a registration invitation scenario, according to one or more embodiments.

Referring to FIG. 1, an account registration processing method provided in this embodiment is applied to a server, and specifically includes step S102 to step S108.

Step S102: Receive a contact method of a target user submitted by a first terminal, and return an information collection page to the first terminal.

The account registration processing method provided in this embodiment is performed by the server. Embodiments of an account registration processing method provided in this specification is performed by a first terminal, and an account registration processing method is performed by a second terminal. The account registration processing method applied to the server provided in this embodiment cooperates with an account registration processing method applied to the first terminal and an account registration processing method applied to the second terminal provided in the following method embodiments in an execution process. Therefore, when this embodiment is read, references can be made to corresponding content in the following method embodiments.

As shown in FIG. 2, a scenario in a schematic diagram of a scenario of the account registration processing method provided in this embodiment includes: a first terminal of an initiating user, a server, and a second terminal of a target user. The first terminal and the second terminal each can be a mobile phone, a tablet computer, a desktop computer, a portable notebook computer, a smart watch, etc. (only a mobile phone is shown in FIG. 2). The server can be an independent server, or can be a server cluster including a plurality of servers.

In actual applications, in a special scenario, it is difficult for a special user to fill in information by using a user terminal. For example, an aged user may have a reduced memory or visual capability and a poor capability of understanding and identifying information, and therefore has a difficulty in filling in registration information in a process of registering a user account. According to the account registration processing method provided in this embodiment, in a registration invitation process, an inviting user fills in registration information on behalf of an invited user, and the invited user only needs to confirm the registration information to implement account registration of the invited user. Specifically, the server receives a contact method of the invited user submitted by the inviting user and returns an information collection page to the inviting user; generates an invitation list based on the registration information of the invited user submitted by the inviting user, and sends, based on the contact method of the invited user, an invitation link generated based on an invitation list identifier to the invited user; displays, after the invited user triggers the invitation link, information to the invited user based on a determined display configuration parameter, and performs account registration based on a registration confirmation instruction submitted by the invited user based on information display; and sends a registration result to the inviting user after registration. As such, operation procedures of the invited user are reduced, and an operation threshold of the invited user is reduced. In addition, the registration result is fed back to the inviting user, so that based on the registration result, the inviting user invites the invited user to enable more services or notify the inviting user of a user registration failure cause.

The first terminal in this embodiment includes a user terminal of the inviting user (the initiating user), and the inviting user is a user who has already registered an account. The inviting user submits a mobile number of the invited user by using the first terminal to complete account registration of the invited user. The invited user is the target user, and a user terminal of the invited user is the second terminal. The inviting user and the invited user can be relatives or friends.

During specific implementation, the initiating user submits a contact method of the target user to the server by using the first terminal through an initial page. To ensure security of the target user, after the contact method of the target user submitted by the first terminal is received, the contact method is verified, and the information collection page is returned to the first terminal only when the verification succeeds. In an optional implementation provided in this embodiment, before the information collection page is returned to the first terminal, the following steps are performed: receiving the contact method, verifying, based on the contact method, whether the target user satisfies a registration condition; and if yes, performing the operation of returning the information collection page to the first terminal; or if no, sending reminding information to the first terminal based on a verification failure type.

Specifically, in the process of verifying, based on the contact method, whether the target user satisfies the registration condition, whether the contact method is registered and whether the contact method is marked in a black/gray list are verified. If the target user does not satisfy the registration condition, a related reason is sent to the first terminal to improve the initiating user's perception of the verification result.

For example, the inviting user submits a contact method of an invited aged user by using the inviting terminal through the initial page shown in FIG. 3. After obtaining the contact method, the server queries a registration record table for whether a registration record of the contact method exists. If no, the server inputs the contact method to a trusted algorithm for trusted verification, and if a verification result output by the trusted algorithm is that the verification succeeds, returns the information collection page shown in FIG. 4 to the inviting terminal. It is worthwhile to note that, the inviting user can view an address book by triggering 301 and select a friend from the address book. The inviting terminal submits the contact method to the server when detecting that a “next” control is triggered. After the inviting terminal displays the information collection page in FIG. 4, the inviting user enters the name and identity of the aged user. The inviting terminal submits registration information of the aged user including the name and the identity to the server when detecting that a “conform” control is triggered.

In actual applications, inviting the target user to register an account implements a marketing effect by enabling more users to participate in services. In this process, a threshold problem of the target user still exists in the account registration process. Therefore, a success rate of inviting a special crowd is relatively low, and the initiating user cannot perceive a registration problem that the target user encounters in account registration and a specific reason, so that time needs to be consumed for repeated communication.

During specific implementation, in this embodiment, in the process in which the initiating user fills in the registration information of the target user by using the information collection page, to improve registration efficiency and avoid a registration failure caused by a format of the registration information filled by the initiating user not satisfying a format condition, validity verification needs to be performed on the registration information of the target user filled by the initiating user. In an optional implementation provided in this embodiment, in a process of collecting the registration information, the first terminal performs the following steps: collecting the registration information entered on the information collection page; verifying whether a format of the registration information satisfies a format condition; and if yes, submitting the registration information when detecting that a confirm control configured on the information collection page is triggered; or if no, displaying a format reminder to remind the initiating user to which the first terminal belongs to re-enter the registration information.

Specifically, in the process in which the initiating user fills in the registration information, the first terminal detects whether the registration information entered by the user satisfies the format condition. If the registration information satisfies the format condition, the first terminal submits, to the server when detecting that the confirm control configured on the information collection page is triggered, the registration information entered by the initiating user. If the registration information does not satisfy the format condition, the first terminal displays the format reminder to remind the initiating user to re-enter the registration information based on the displayed format reminder.

As shown in FIG. 2, when the initiating user invites the target user to perform account registration, the initiating user submits the contact method of the target user to the server by using the first terminal; the server verifies whether the contact method satisfies a registration invitation condition, and if no, sends the reminding information to the first terminal based on the verification failure type, or if yes, return the information collection page to the first terminal; and the first terminal submits the registration information of the target user to the server by using the information collection page.

Step S104: Generate an invitation list based on registration information entered based on the information collection page and submitted by the first terminal, and send, based on the contact method, an invitation link generated based on the invitation list to a second terminal.

The invitation list is generated based on the registration information and identity information of the initiating user, and the invitation list further includes an invitation state and a registration response result. The invitation state in the invitation list includes WAITING, PENDING, REGISTERING, SUCCESS, and/or FAIL. If the invitation state is “FAIL”, the registration failure cause is added to the registration response result.

During specific implementation, after the registration information submitted by the first terminal is received, the invitation list is generated based on the identity information of the initiating user and the registration information of the target user, and the invitation link is generated based on the invitation list and sent to the second terminal of the target user. As shown in FIG. 2, the server creates the invitation list based on the registration information, creates the invitation link based on an invitation list identifier of the invitation list, and sends the invitation link to the second terminal of the target user. In an optional implementation provided in this embodiment, in the process of sending the invitation link to the second terminal based on the contact method, the following steps are performed: generating the invitation link based on the invitation list identifier of the invitation list; and sending, to the target user based on the contact method, a registration reminder including the invitation link, and sending, to the first terminal, a waiting reminder indicating that the registration reminder has been sent.

Specifically, after the contact method submitted by the first terminal is received, identity information that has an association relationship with a user account associated with the first terminal is read by using the user account, the invitation list is created based on the identity information of the initiating user and the registration information of the target user, the invitation link is generated based on the invitation list identifier, and the registration reminder including the invitation link is sent to the second terminal based on the contact method.

For example, identity information that has an association relationship with a user account of the inviting user associated with the inviting terminal is queried based on the user account, and the invitation list shown in Table 1 is created based on the inviter account ID, and the registration information that includes the name and the identity of the aged user “user B” and that is submitted by the inviting user by using the inviting terminal through the information collection page shown in FIG. 4. In an early stage of creating the invitation list, the invitation state is “WAITING”, the invitation list ID is concatenated in an original invitation link to re-generate a short link, and the short link is sent to the aged user “user B” by using a message, etc. To enable the inviting user to perceive an invitation progress in time, after the message is sent to the aged user “user B”, a waiting reminder page shown in FIG. 5 is sent to the inviting user, and the inviting user can send, to the aged user by using the waiting reminder, a message including the short link.

TABLE 1

| | | | | | |
|---|---|---|---|---|---|
| | Inviter | Contact | Registration | Registration | |
| Invitation | account | method of | information of | response | Invitation |
| list ID | ID | the invitee | the invitee | result | state |

| | | | | |
|---|---|---|---|---|
| 20210301 | 2088001 | 135xxxx0000 | Name: User B; | WAITING |
| | | | identity: | |
| | | | 1000xxxx001 | |

As shown in FIG. 5, the waiting reminder page sent to the inviting user includes specific content of an invitation message sent to the aged user “user B”, and a “Send message again” control is configured. If the invitation link in the invitation message is not triggered by the aged user “user B” in a certain period of time, the “Send message again” control can be triggered to send the invitation message to the aged user “user B” again.

It is worthwhile to note that, after the invitation list is created, to enable the initiating user to view the invitation state in the invitation list at any time, a viewing reminder that includes the invitation list identifier is sent to the first terminal of the initiating user. In an optional implementation provided in this embodiment, the initiating user views the invitation state in the following way: sending a viewing reminder of viewing the invitation list to the first terminal based on the invitation list identifier of the invitation list; and after the viewing reminder is triggered, querying the invitation state recorded in the invitation list, and sending the invitation state to the first terminal. Specifically, after the initiating user submits an access request for the viewing reminder, the invitation state in the corresponding invitation list is viewed based on the invitation list identifier included in the access request, and the invitation state is sent to the initiating user.

Step S106: Determine a display configuration parameter of the target user based on the registration information after the invitation link is triggered.

The display configuration parameter includes a font, display text, etc., used on a display page when the registration information is displayed to the target user.

During specific implementation, after the target user triggers the invitation link, a displayed page style is determined by identifying a user characteristic type in the registration information, for example, aged peoples over 60 years old, and a large-character page is used to render guide text of interest to the aged peoples to enhance registration intentions of the aged people. In an optional implementation provided in this embodiment, in the process of determining the display configuration parameter of the target user based on the registration information after the invitation link is triggered, the following steps are performed: after the invitation link is triggered, reading recorded content in the invitation list based on the invitation list identifier included in the invitation link; parsing an identity card identifier of the target user in the recorded content to obtain a user characteristic type of the target user; and inputting the user characteristic type to a parameter configuration algorithm to perform parameter configuration, to obtain the display configuration parameter.

Specifically, the identity card identifier of the target user is parsed to obtain the user characteristic type (for example, a first user characteristic and a second user characteristic) of the target user, the user characteristic type is input to the parameter configuration algorithm, and the parameter configuration algorithm determines, based on the user characteristic type, a display font and display text used in the process of displaying the registration information to the target user. For example, based on an access request for the invitation link submitted by the aged user “user B”, information recorded in the invitation list is queried based on the invitation list identifier in the invitation link, and the found identity of the aged user is parsed to learn that the aged user “user B” is a male and 63 years old. The two user features, that is, “male” and “63 years old”, are input to the parameter configuration algorithm, to learn that a display font type output by the parameter configuration algorithm is a large font, and the guide text is “Register to view stock trends”.

During specific implementation, after the display configuration parameter output by the parameter configuration algorithm is obtained, the registration confirmation page is rendered based on the display configuration parameter and the recorded information in the invitation list, and is displayed by using the second terminal of the target user. In an optional implementation provided in this embodiment, after the display configuration parameter is obtained, the following steps are performed: rendering, based on the display configuration parameter, the registration confirmation page that includes the registration information and an identity in identity information; and displaying the registration confirmation page by using the second terminal, where the identity information is identity information that is read based on account information of the first terminal and that has an association relationship with the account information.

It is worthwhile to note that, the registration confirmation page can be rendered by the server. Specifically, the server generates the registration confirmation page based on the obtained display configuration parameter, and sends the registration confirmation page to the second terminal, so that the second terminal displays the registration confirmation page. In addition, the second terminal can render the registration confirmation page. Specifically, after obtaining the display configuration parameter, the server sends the display configuration parameter and the recorded information to the second terminal, and the second terminal renders the registration confirmation page based on the display configuration parameter and the recorded information and displays the registration confirmation page.

As shown in FIG. 6, after the display configuration parameter determined based on the first user characteristic and the second user characteristic of the aged user “user B”, the display configuration parameter, the name “user A” of the inviting user determined based on the inviter account ID, and the name, the contact method, and the identity of the aged user “user B” are sent to the invited terminal of the aged user “user B”, and the invited terminal renders the registration confirmation page based on the previous information and displays the registration confirmation page. In addition, in an account registration process, an authorization instruction for a service privacy protocol needs to be obtained. To further simplify an operation procedure, an authorization reminder for the service privacy protocol is rendered on the registration confirmation page. After confirming that the name, the contact method, and the identity are correct, the aged user can submit a registration confirmation request by triggering a “Confirm, and direct register using the current phone number” control configured on the registration confirmation page. The registration confirmation page includes the name of user A, and includes the name, the mobile number, and the identity of the aged user “user B”. In addition, the guide text “Register to view stock trends” for the aged user “user B” is further rendered.

It is worthwhile to note that, after the target user accesses the invitation link, the invitation state in the invitation list is updated to “PENDING”; and after the target user submits the registration confirmation instruction by using the registration confirmation page, the invitation state in the invitation list is updated to “REGISTERING”, so that the initiating user can view the invitation state.

As shown in FIG. 2, when detecting that the invitation link is triggered, the server reads the recorded information in the invitation list based on the invitation list identifier; the server parses the identity card identifier in the recorded information to obtain the user characteristic type of the target user; the server inputs the user characteristic type to the parameter configuration algorithm to perform parameter configuration, to obtain the display configuration parameter for the target user; the server renders an information display page based on the display configuration parameter and the recorded information; the server sends the information display page to the second terminal, so that the second terminal displays the information display page to the target user; and the server obtains a registration confirmation reminder that is of the target user for the recorded information and that is submitted by the second terminal, performs account registration based on the registration confirmation reminder, and sends a registration result to the first terminal, so that the first terminal displays the registration result to the initiating user.

Step S108: Perform account registration based on the registration information and send a registration result to the first terminal if a registration confirmation instruction submitted after the second terminal displays information based on the display configuration parameter is received.

During specific implementation, after the registration confirmation request submitted by the target user by using the registration confirmation page displayed by the second terminal is received, account registration is performed based on the contact method and the registration information of the target user. In an optional implementation provided in this embodiment, account registration is performed in the following way: generating an account identifier based on an account identifier generation algorithm; establishing an association relationship between the account identifier and each of the registration information and the contact method; and sending the account identifier to the target user by using the second terminal.

Specifically, the account identifier is generated by using the account identifier generation algorithm, and then the association relationship between the account identifier and each of the contact method and the registration information of the target user is established, so as to allocate the account identifier to the target user. In addition, in the account registration process, the contact method and the registration information of the target user can be further input to the account identifier generation algorithm obtain the account identifier that is output by the account identifier generation algorithm and that has an association relationship with the contact method and the registration information, and the account identifier is determined as an account identifier of the target user.

To improve perception of the initiating user for an invitation progress, after the target user succeeds in registration or fails in registration, the invitation list is updated, and an updated registration result is sent to the first terminal. In an optional implementation provided in this embodiment, after account registration is performed, the invitation state in the invitation list is first updated based on the registration result, and then the registration result is sent to the first terminal based on the invitation state. If the registration result is “SUCCESS”, the registration result “SUCCESS” is updated to the invitation list; or if the registration result is “FAIL”, a registration failure cause is read, and the registration failure cause and the registration result “FAIL” are updated to the invitation list.

Specifically, if the registration succeeds, the invitation state in the invitation list is updated to “SUCCESS”, and a registration success reminder is sent to the first terminal, to guide the initiating user to add a user account of the target user as a friend or invite the target user to enable more services. If the registration fails, the invitation state in the invitation list is updated to “FAIL”, the registration response result is updated to a failure cause, and a registration failure reminder including the failure cause is sent to the first terminal, to guide the initiating user to attempt to perform invitation in another way. It is worthwhile to note that, when a registration result reminder is sent to the initiating user, the invitation list ID can be concatenated in an original notification link to re-generate a short link, and the registration result is sent to the initiating user through intra-station information, etc. If an access request of the initiating user for the short link is detected, the invitation state in the invitation list is queried based on the invitation ID in the access request, and the invitation state is displayed to the initiating user.

The following describes an invitation processing procedure provided in an embodiment.

FIG. 7 is a processing flowchart illustrating an invitation processing procedure, which specifically includes the following step S702 to step S712. It is worthwhile to note that, the invitation processing procedure provided in this embodiment cooperates with the following invitation processing procedure applied to the first terminal in an execution process.

Step S702: Obtain a contact method of an aged user submitted by an inviting user by using a first terminal.

Step S704: Invoke a registration record table to query whether the contact method has been registered; and if yes, send a user registered reminder to the inviting user; or if no, perform step S706 to step S712.

Step S706: Input the contact method to a trusted algorithm for trusted verification to obtain a verification result.

Step S708: If the verification result is that the verification succeeds, return an information collection page to the first terminal.

Step S710: Obtain registration information of the aged user submitted by the inviting user by using the first terminal.

Step S712: Create an invitation list based on the registration information and identity information of the inviting user.

The following describes a registration processing procedure provided in an embodiment.

FIG. 8 is a processing flowchart illustrating a registration processing procedure, which specifically includes the following step S802 to step S814. It is worthwhile to note that, the registration processing procedure provided in this embodiment cooperates with the following registration processing procedure applied to the second terminal in an execution process.

Step S802: Generate an invitation link based on an invitation list identifier, and send the invitation link to a second terminal of an aged user.

Step S804: When an access request for the invitation link submitted by the second terminal is detected, read recorded information in the invitation list based on the invitation list identifier in the access request.

Step S806: Parse an identity card identifier in the recorded information to obtain a user characteristic type of the aged user.

Step S808: Input the user characteristic type to a parameter configuration algorithm to perform parameter configuration, to obtain a display configuration parameter.

Step S810: Send the display configuration parameter and the recorded information to the second terminal, so that the second terminal renders a registration confirmation page and displays the registration confirmation page.

Step S812: If a registration confirmation instruction submitted by the second terminal is received, perform account registration based on registration information and a contact method of the aged user.

Step S814: When the registration succeeds, allocate, to the second terminal, a user account that has an association relationship with the contact method and the registration information of the aged user.

The account registration processing method provided in this embodiment is further described by using an example in which the account registration processing method provided in this embodiment is applied to a registration invitation scenario. Referring to FIG. 9, the account registration processing method applied to the registration invitation scenario includes the following steps.

Step S908: A server creates an invitation list based on registration information of an aged user and an identity of an inviting user.

Before this, a first terminal submits a contact method of the aged user to the server, the first terminal receives an information collection page returned by the server, and the first terminal submits the registration information of the aged user to the server based on the information collection page.

Step S910: The server generates an invitation link based on an invitation list identifier of the invitation list, sends the invitation link to a second terminal, and sends a waiting reminder to the first terminal after sending the invitation link to the second terminal.

Afterward, the second terminal submits an access request for the invitation link to the server.

Step S914: Read recorded information in the invitation list based on the invitation list identifier included in the access request.

Step S916: Parse an identity card identifier of the aged user, and determine a display configuration parameter based on a user characteristic type obtained through parsing.

Step S918: Send the display configuration parameter, and the registration information of the aged user and the identity of the inviting user in the recorded information to the second terminal.

Afterwards, the second terminal renders, based on the display configuration parameter, a registration confirmation page that includes the registration information and the identity, and displays the registration confirmation page. The second terminal submits a registration confirmation instruction for the registration information to the server.

Step S924: Perform account registration based on the registration confirmation instruction, and send a registration result to the first terminal.

In conclusion, according to the account registration processing method provided in this embodiment, the contact method of the target user submitted by the first terminal is first received, and the information collection page is returned to the first terminal; then, the invitation list is generated based on the registration information entered based on the information collection page and submitted by the first terminal, and the invitation link generated based on the invitation list is sent to the second terminal based on the contact method; further, the display configuration parameter of the target user is determined based on the registration information after the invitation link is triggered; and if the registration confirmation instruction submitted after the second terminal displays information based on the display configuration parameter is received, account registration is performed based on the registration information, and the registration result is sent to the first terminal. As such, the inviting user performs a registration invitation, so as to reduce operations that a special group needs to perform in an account registration process, and reduce an account registration threshold.

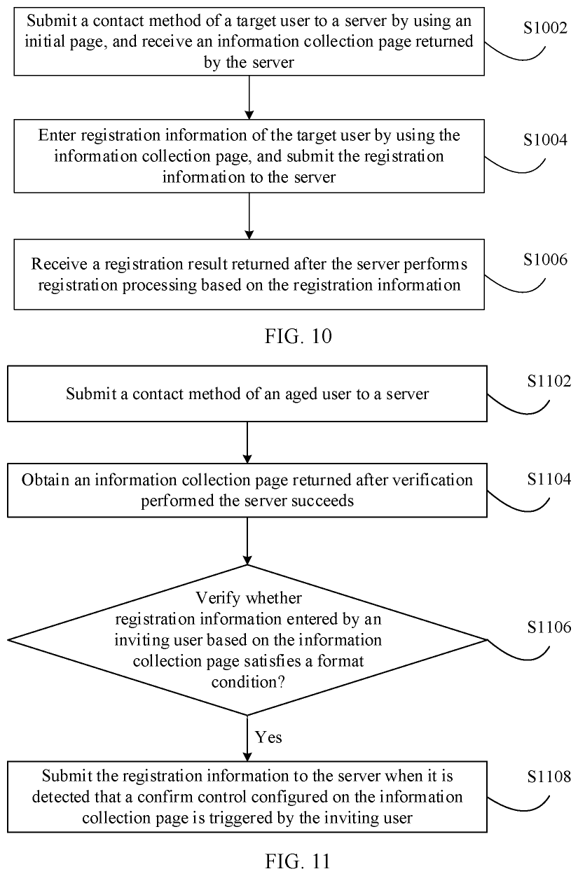

According to embodiments of a second account registration processing method provided in this specification, FIG. 10 is a processing flowchart illustrating an account registration processing method, according to one or more embodiments, FIG. 2 is a schematic diagram illustrating a scenario of an account registration processing method, according to one or more embodiments, FIG. 3 is a schematic diagram illustrating an initial page, according to one or more embodiments, FIG. 4 is a schematic diagram illustrating an information collection page, according to one or more embodiments, FIG. 5 is a schematic diagram illustrating a waiting reminder page according to one or more embodiments, FIG. 6 is a schematic diagram illustrating a registration confirmation page, according to one or more embodiments, FIG. 9 is a diagram illustrating a sequence of an account registration processing method applied to a registration invitation scenario, according to one or more embodiments, and FIG. 11 is a processing flowchart illustrating an invitation processing procedure, according to one or more embodiments.

Referring to FIG. 10, the account registration processing method provided in this embodiment is applied to a first terminal, and specifically includes step S1002 to step S1006.

Step S1002: Submit a contact method of a target user to a server by using an initial page, and receive an information collection page returned by the server.

In actual applications, a special group (for example, a group of aged peoples) may have a reduced memory or visual capability and a poor capability of understanding and identifying information, and therefore has a difficulty in filling in registration information in a process of registering a user account. According to the account registration processing method provided in this embodiment, in a registration invitation process, an inviting user fills in registration information on behalf of an invited user, and the invited user only needs to confirm the registration information to implement account registration of the invited user. Specifically, the server receives a contact method of the invited user submitted by the inviting user and returns an information collection page to the inviting user; generates an invitation list based on the registration information of the invited user submitted by the inviting user, and sends, based on the contact method of the invited user, an invitation link generated based on an invitation list identifier to the invited user; displays, after the invited user triggers the invitation link, information to the invited user based on a determined display configuration parameter, and performs account registration based on a registration confirmation instruction submitted by the invited user based on information display; and sends a registration result to the inviting user after registration. As such, operation procedures of the invited user are reduced, and an operation threshold of the invited user is reduced. In addition, the registration result is fed back to the inviting user, so that based on the registration result, the inviting user invites the invited user to enable more services or notify the inviting user of a user registration failure cause.

The first terminal in this embodiment includes a user terminal of the inviting user (initiating user), and the inviting user is a user who has already registered an account. The inviting user submits a mobile number of the invited user by using the first terminal to complete account registration of the invited user. The invited user is the target user, and a user terminal of the invited user is the second terminal.

As shown in FIG. 2, a scenario in a schematic diagram of a scenario of the account registration processing method provided in this embodiment includes: a first terminal of an initiating user, a server, and a second terminal of a target user. The first terminal and the second terminal each can be a mobile phone, a tablet computer, a desktop computer, a portable notebook computer, a smart watch, etc. (only a mobile phone is shown in FIG. 2). The server can be an independent server, or can be a server cluster including a plurality of servers.

During specific implementation, the initiating user submits a contact method of the target user to the server by using the first terminal. To ensure security of the target user, after receiving the contact method of the target user submitted by the first terminal, the server verifies the contact method, and returns the information collection page to the first terminal only when the verification succeeds. Before returning the information collection page, the server performs the following step: receiving the contact method; verifying, based on the contact method, whether the target user satisfies a registration condition; and if yes, performing the operation of returning the information collection page to the first terminal; or if no, sending reminding information to the first terminal based on a verification failure type.

Specifically, in the process of verifying, based on the contact method, whether the target user satisfies the registration condition, the server verifies whether the contact method is registered and whether the contact method is marked in a black/gray list. If the target user does not satisfy the registration condition, a related reason is sent to the first terminal to improve the initiating user's perception of the verification result.

For example, the inviting user submits a contact method of an invited aged user by using the inviting terminal through the initial page shown in FIG. 3. After obtaining the contact method, the server queries a registration record table for whether a registration record of the contact method exists. If no, the server inputs the contact method to a trusted algorithm for trusted verification, and if a verification result output by the trusted algorithm is that the verification succeeds, returns the information collection page shown in FIG. 4 to the inviting terminal. It is worthwhile to note that, the inviting user can view an address book by triggering 301 and select a friend from the address book. The inviting terminal submits the contact method to the server when detecting that a “next” control is triggered. After the inviting terminal displays the information collection page in FIG. 4, the inviting user enters the name and identity of the aged user. The inviting terminal submits registration information of the aged user including the name and the identity to the server when detecting that a “conform” control is triggered.

Step S1004: Enter registration information of the target user by using the information collection page, and submit the registration information to the server.

In actual applications, inviting the target user to register an account implements a marketing effect through sharing, and a threshold problem of the target user still exists in the account registration process. Therefore, a success rate of inviting a special group is relatively low, and the initiating user cannot perceive a registration problem that the target user encounters in account registration and a specific reason, so that time needs to be consumed for repeated communication. In this embodiment, the initiating user fills in the registration information of the target user to complete account registration of the target user.

During specific implementation, in the process in which the initiating user fills in the registration information of the target user by using the information collection page, to improve registration efficiency and avoid a registration failure caused by a format of the registration information filled by the initiating user not satisfying a format condition, validity verification needs to be performed on the registration information of the target user filled by the initiating user. In an optional implementation provided in this embodiment, in a process of collecting the registration information, the first terminal performs the following steps: collecting the registration information entered on the information collection page; verifying whether a format of the registration information satisfies a format condition; and if yes, submitting the registration information when detecting that a confirm control configured on the information collection page is triggered; or if no, displaying a format reminder to remind the initiating user to which the first terminal belongs to re-enter the registration information.

Specifically, in the process in which the initiating user fills in the registration information, the first terminal detects whether the registration information entered by the user satisfies the format condition. If the registration information satisfies the format condition, the first terminal submits, to the server when detecting that the confirm control configured on the information collection page is triggered, the registration information entered by the initiating user. If the registration information does not satisfy the format condition, the first terminal displays the format reminder to remind the initiating user to re-enter the registration information based on the displayed format reminder.

After receiving the registration information, the server generates the invitation list based on the registration information entered based on the information collection page and submitted by the first terminal, and sends, based on the contact method, the invitation link generated based on the invitation list to the second terminal. The invitation list is generated based on the registration information and identity information of the initiating user, and the invitation list further includes an invitation state and a registration response result. The invitation state in the invitation list includes WAITING, PENDING, REGISTERING, SUCCESS, and/or FAIL. If the invitation state is “FAIL”, the registration failure cause is added to the registration response result.

During specific implementation, after receiving the registration information submitted by the first terminal, the server generates the invitation list based on the identity information of the initiating user and the registration information of the target user, and generates the invitation link based on the invitation list and sends the invitation link to the second terminal of the target user. In the process of sending the invitation link to the second terminal based on the contact method, the server performs the following steps: generating the invitation link based on the invitation list identifier of the invitation list; and sending, to the target user based on the contact method, a registration reminder including the invitation link, and sending, to the first terminal, a waiting reminder indicating that the registration reminder has been sent.

Specifically, after receiving the contact method submitted by the first terminal, the server reads, by using a user account associated with the first terminal, identity information that has an association relationship with the user account, creates the invitation list based on the identity information of the initiating user and the registration information of the target user, generates the invitation link based on the invitation list identifier, and sends the registration reminder including the invitation link to the second terminal based on the contact method.

For example, the server queries, based on a user account of the inviting user associated with the inviting terminal, identity information that has an association relationship with the user account, and creates the invitation list shown in Table 1 based on a name “user A” of the inviting user determined based on the inviter account ID, and the registration information that includes the name and the identity of the aged user “user B” and that is submitted by the inviting user by using the inviting terminal through the information collection page shown in FIG. 4. In an early stage of creating the invitation list, the invitation state is “WAITING”, the invitation list ID is concatenated in an original invitation link to re-generate a short link, and the short link is sent to the aged user “user B” by using a message, etc. To enable the inviting user to perceive an invitation progress in time, after the short message is sent to the aged user “user B”, a waiting reminder page shown in FIG. 5 is sent to the inviting user, and the inviting user can send, to the aged user by using the waiting reminder, a short message including the short link.

TABLE 1

| | | | | | |
|---|---|---|---|---|---|
| | Inviter | Contact | Registration | Registration | |
| Invitation | account | method of | information of | response | Invitation |
| list ID | ID | the invitee | the invitee | result | state |

| | | | | |
|---|---|---|---|---|
| 20210301 | 2088001 | 135xxxx0000 | Name: User B; | WAITING |
| | | | identity: | |
| | | | 1000xxxx001 | |

As shown in FIG. 5, the waiting reminder page sent to the inviting user includes specific content of an invitation message sent to the aged user “user B”, and a “Send message again” control is configured. If the invitation link in the invitation message is not triggered by the aged user “user B” in a certain period of time, the “Send message again” control can be triggered to send the invitation message to the aged user “user B” again.

It is worthwhile to note that, after the invitation list is created, to enable the initiating user to view the invitation state in the invitation list at any time, the server sends, the first terminal of the initiating user, a viewing reminder that includes the invitation list identifier. Specifically, the initiating user views the invitation state in the following way: sending a viewing reminder of viewing the invitation list to the first terminal based on the invitation list identifier of the invitation list; and after the viewing reminder is triggered, querying the invitation state recorded in the invitation list, and sending the invitation state to the first terminal. In an optional implementation provided in this embodiment, an invitation list reminder that includes the invitation list identifier and that is sent by the server is received, and after the invitation list reminder is triggered, the invitation state recorded in the invitation list is obtained. After the initiating user submits an access request for the viewing reminder, the invitation state in the corresponding invitation list is viewed based on the invitation list identifier included in the access request, and the invitation state is sent to the initiating user.

After sending the invitation link to the second terminal, the server determines a display configuration parameter of the target user based on the registration information after the invitation link is triggered. The display configuration parameter includes a font, display text, etc., used on a display page when the registration information is displayed to the target user.

During specific implementation, after the target user triggers the invitation link, the server identifies a user characteristic type in the registration information, for example, aged peoples over 60 years old, to determine a displayed page style, and uses a large-character page to render guide text of interest to the aged peoples to enhance registration intentions of the aged people. In the process of determining the display configuration parameter of the target user based on the registration information after the invitation link is triggered, the server performs the following steps: after the invitation link is triggered, reading recorded content in the invitation list based on the invitation list identifier included in the invitation link; parsing an identity card identifier of the target user in the recorded content to obtain a user characteristic type of the target user; and inputting the user characteristic type to a parameter configuration algorithm to perform parameter configuration, to obtain the display configuration parameter.

Specifically, the server parses the identity card identifier of the target user to obtain the user characteristic type (for example, a first user characteristic and a second user characteristic) of the target user, and inputs the user characteristic type to the parameter configuration algorithm, and the parameter configuration algorithm determines, based on the user characteristic type, a display font and display text used in the process of displaying the registration information to the target user.

For example, after obtaining an access request that is for the invitation link and that is submitted by the aged user “user B”, the server queries information recorded in the corresponding invitation list based on the invitation list identifier in the invitation link, parses the found identity of the aged user to learn that the aged user “user B” is a male and 63 years old, and inputs the two user features, that is, “male” and “63 years old”, to the parameter configuration algorithm, to learn that a display font type output by the parameter configuration algorithm is a large font, and the guide text is “Register to view stock trends”.

During specific implementation, after obtaining the display configuration parameter output by the parameter configuration algorithm, the server renders the registration confirmation page based on the display configuration parameter and the recorded information in the invitation list, and displays the registration confirmation page by using the second terminal of the target user. After obtaining the display configuration parameter, the server performs the following steps: rendering, based on the display configuration parameter, the registration confirmation page that includes the registration information and an identity in identity information; and displaying the registration confirmation page by using the second terminal, where the identity information is identity information that is read based on account information of the first terminal and that has an association relationship with the account information.

It is worthwhile to note that, the registration confirmation page can be rendered by the server. Specifically, the server generates the registration confirmation page based on the obtained display configuration parameter, and sends the registration confirmation page to the second terminal, so that the second terminal displays the registration confirmation page. In addition, the second terminal can render the registration confirmation page. Specifically, after obtaining the display configuration parameter, the server sends the display configuration parameter and the recorded information to the second terminal, and the second terminal renders the registration confirmation page based on the display configuration parameter and the recorded information and displays the registration confirmation page.

As shown in FIG. 6, after obtaining the display configuration parameter determined based on the first user characteristic and the second user characteristic of the aged user “user B”, the server send, to the invited terminal of the aged user “user B”, the display configuration parameter, the name “user A” of the inviting user determined based on the inviter account ID, and the name, the contact method, and the identity of the aged user “user B”, and the invited terminal renders the registration confirmation page based on the previous information and displays the registration confirmation page. In addition, in an account registration process, an authorization instruction for a service privacy protocol needs to be obtained. To further simplify an operation procedure, an authorization reminder for the service privacy protocol is rendered on the registration confirmation page. After confirming that the name, the contact method, and the identity are correct, the aged user can submit a registration confirmation request by triggering a “Confirm, and direct register using the current phone number” control configured on the registration confirmation page. The registration confirmation page includes the name of user A, and includes the name, the mobile number, and the identity of the aged user “user B”. In addition, the guide text “Register to view stock trends” for the aged user “user B” is further rendered.

It is worthwhile to note that, after the target user accesses the invitation link, the server updates the invitation state in the invitation list to “PENDING”; and after the target user submits the registration confirmation instruction by using the registration confirmation page, the server updates the invitation state in the invitation list to “REGISTERING”, so that the initiating user can view the invitation state.

During specific implementation, if the server receives the registration confirmation instruction submitted after the second terminal displays the information based on the display configuration parameter, the server performs account registration based on the registration information, and sends the registration result to the first terminal. After obtaining the registration confirmation request submitted by the target user by using the registration confirmation page displayed by the second terminal, the server performs account registration based on the contact method and the registration information of the target user. The server performs account registration in the following way: generating an account identifier based on an account identifier generation algorithm; establishing an association relationship between the account identifier and each of the registration information and the contact method; and sending the account identifier to the target user by using the second terminal.

Specifically, the account identifier is generated by using the account identifier generation algorithm, and then the association relationship between the account identifier and each of the contact method and the registration information of the target user is established, so as to allocate the account identifier to the target user. In addition, in the account registration process, the contact method and the registration information of the target user can be further input to the account identifier generation algorithm obtain the account identifier that is output by the account identifier generation algorithm and that has an association relationship with the contact method and the registration information, and the account identifier is determined as an account identifier of the target user.

To improve perception of the initiating user for an invitation progress, after the target user succeeds in registration or fails in registration, the server updates the invitation list, and sends an updated registration result to the first terminal. After performing account registration, the server first updates the invitation state in the invitation list based on the registration result, and then sends the registration result to the first terminal based on the invitation state. If the registration result is “SUCCESS”, the registration result “SUCCESS” is updated to the invitation list; or if the registration result is “FAIL”, a registration failure cause is read, and the registration failure cause and the registration result “FAIL” are updated to the invitation list.

Specifically, if the registration succeeds, the invitation state in the invitation list is updated to “SUCCESS”, and a registration success reminder is sent to the first terminal, to guide the initiating user to add a user account of the target user as a friend or invite the target user to enable more services. If the registration fails, the invitation state in the invitation list is updated to “FAIL”, the registration response result is updated to a failure cause, and a registration failure reminder including the failure cause is sent to the first terminal, to guide the initiating user to attempt to perform invitation in another way. It is worthwhile to note that, when a registration result reminder is sent to the initiating user, the invitation list ID can be concatenated in an original notification link to re-generate a short link, and the registration result is sent to the initiating user through intra-station information, etc. If an access request of the initiating user for the short link is detected, the invitation state in the invitation list is queried based on the invitation ID in the access request, and the invitation state is displayed to the initiating user.

Step S1006: Receive a registration result returned after the server performs registration processing based on the registration information.

As shown in FIG. 2, when the initiating user invites the target user to perform account registration, the initiating user submits the contact method of the target user to the server by using the first terminal; the server verifies whether the contact method satisfies the registration invitation condition, and if no, sends the reminding information to the first terminal based on the verification failure type, or if yes, returns the information collection page to the first terminal; the first terminal submits the registration information of the target user to the server by using the information collection page; the server creates the invitation list based on the registration information, and creates the invitation link based on the invitation list identifier of the invitation list, and sends the invitation link to the second terminal of the target user; the server reads the recorded information in the invitation list based on the invitation list identifier when detecting that the invitation link is triggered; the server parses the identity card identifier in the recorded information to obtain the user characteristic type of the target user; the server inputs the user characteristic type to the parameter configuration algorithm to perform parameter configuration, to obtain the display configuration parameter for the target user; the server renders an information display page based on the display configuration parameter and the recorded information; the server sends the information display page to the second terminal, so that the second terminal displays the information display page to the target user; and the server obtains the registration confirmation reminder that is of the target user for the recorded information and that is submitted by the second terminal, performs account registration based on the registration confirmation reminder, and sends the registration result to the first terminal, so that the first terminal displays the registration result to the initiating user.

The following describes an invitation processing procedure provided in an embodiment. FIG. 11 is a processing flowchart illustrating an invitation processing procedure, which specifically includes the following step S1102 to step S1108. It is worthwhile to note that, the invitation processing procedure provided in this embodiment cooperates with the previously described invitation processing procedure applied to the server in an execution process.

Step S1102: Submit a contact method of an aged user to a server.

Step S1104: Obtain an information collection page returned after verification performed the server succeeds.

Step S1106: Verify whether registration information entered by an inviting user based on the information collection page satisfies a format condition; and if yes, perform step S1108; or if no, display a format reminder to guide the inviting user to re-enter the registration information.

Step S1108: Submit the registration information to the server when it is detected that a confirm control configured on the information collection page is triggered by the inviting user.

The account registration processing method provided in this embodiment is further described by using an example in which the account registration processing method provided in this embodiment is applied to a registration invitation scenario. Referring to FIG. 9, the account registration processing method applied to the registration invitation scenario includes the following steps.

Step S902: Submit a contact method of an aged user to a server.

Step S904: Receive an information collection page returned by the server.

Step S906: Submit registration information of the aged user to the server based on the information collection page.

Afterwards, the server creates an invitation list based on the registration information of the aged user and an identity of and inviting user; and generates an invitation link based on an invitation list identifier of the invitation list, sends the invitation link to a second terminal, and sends a waiting reminder to a first terminal after sending the invitation link to the second terminal. The second terminal submits an access request for the invitation link to the server. The server reads recorded information in the invitation list based on the invitation list identifier included in the access request, parses an identity card identifier of the aged user, and determines a display configuration parameter based on the user characteristic type through parsing; and sends, to the second terminal, the display configuration parameter and the registration information of the aged user and the identity of the inviting user in the recorded information. The second terminal renders a registration confirmation page that includes the registration information and the identity based on the display configuration parameter, and displays the registration confirmation page. The second terminal submits a registration confirmation instruction for the registration information to the server. The server performs account registration based on the registration confirmation instruction, and sends a registration result to the first terminal.

In conclusion, in the account registration processing method provided in this embodiment, the contact method of the target user is first submitted to the server by using the initial page, and the information collection page returned by the server is received; then, the registration information of the target user is entered by using the information collection page, and the registration information is submitted to the server; and finally, the registration result returned after the server performs registration processing based on the registration information is received. As such, the contact method and the registration information of the target user are filled in to invite the target user to perform account registration.

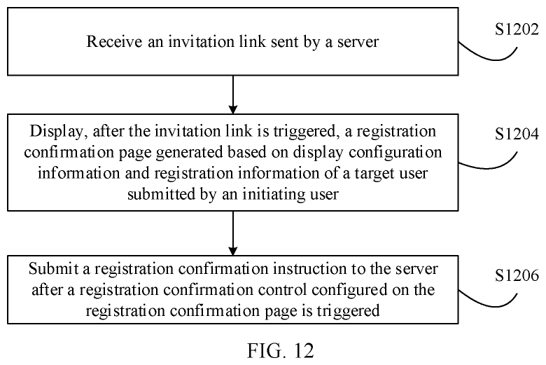

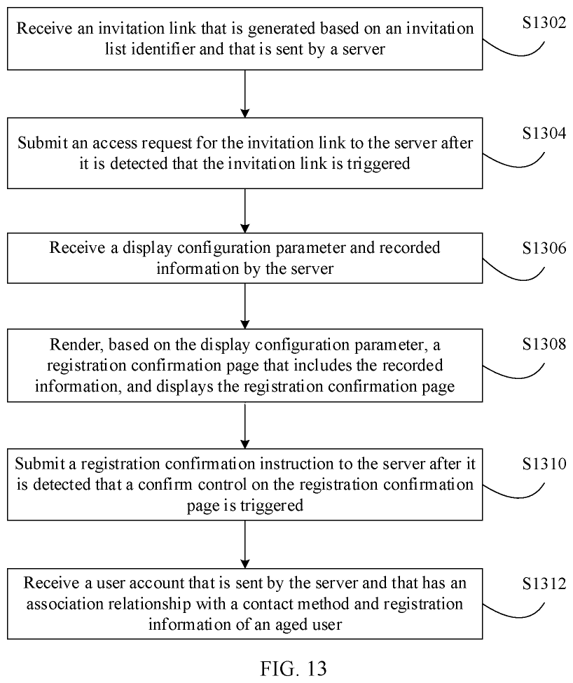

According to embodiments of a third account registration processing method provided in this specification, FIG. 12 is a processing flowchart illustrating an account registration processing method, according to one or more embodiments, FIG. 2 is a schematic diagram illustrating a scenario of an account registration processing method, according to one or more embodiments, FIG. 3 is a schematic diagram illustrating an initial page, according to one or more embodiments, FIG. 4 is a schematic diagram illustrating an information collection page, according to one or more embodiments, FIG. 5 is a schematic diagram illustrating a waiting reminder page, according to one or more embodiments, FIG. 6 is a schematic diagram illustrating a registration confirmation page, according to one or more embodiments, FIG. 9 is a diagram illustrating a sequence of an account registration processing method applied to a registration invitation scenario, according to one or more embodiments, and FIG. 13 is a processing flowchart illustrating a registration processing procedure, according to one or more embodiments.

Referring to FIG. 12, the account registration processing method provided in this embodiment is applied to a second terminal, and specifically includes step S1202 to step S1206.

Step S1202: Receive an invitation link sent by a server.

In actual applications, a special group (for example, a group of aged peoples) may have a reduced memory or visual capability and a poor capability of understanding and identifying information, and therefore has a difficulty in filling in registration information in a process of registering a user account. According to the account registration processing method provided in this embodiment, in a registration invitation process, an inviting user fills in registration information on behalf of an invited user, and the invited user only needs to confirm the registration information to implement account registration of the invited user. Specifically, the server receives a contact method of the invited user submitted by the inviting user and returns an information collection page to the inviting user; generates an invitation list based on the registration information of the invited user submitted by the inviting user, and sends, based on the contact method of the invited user, an invitation link generated based on an invitation list identifier to the invited user; displays, after the invited user triggers the invitation link, information to the invited user based on a determined display configuration parameter, and performs account registration based on a registration confirmation instruction submitted by the invited user based on information display; and sends a registration result to the inviting user after registration. As such, operation procedures of the invited user are reduced, and an operation threshold of the invited user is reduced. In addition, the registration result is fed back to the inviting user, so that based on the registration result, the inviting user invites the invited user to enable more services or notify the inviting user of a user registration failure cause.

The first terminal in this embodiment includes a user terminal of the inviting user (initiating user), and the inviting user is a user who has already registered an account. The inviting user submits a mobile number of the invited user by using the first terminal to complete account registration of the invited user. The invited user is the target user, and a user terminal of the invited user is the second terminal.

As shown in FIG. 2, a scenario in a schematic diagram of a scenario of the account registration processing method provided in this embodiment includes: a first terminal of an initiating user, a server, and a second terminal of a target user. The first terminal and the second terminal each can be a mobile phone, a tablet computer, a desktop computer, a portable notebook computer, a smart watch, etc. (only a mobile phone is shown in FIG. 2). The server can be an independent server, or can be a server cluster including a plurality of servers.

During specific implementation, the initiating user submits a contact method of the target user to the server by using the first terminal. To ensure security of the target user, after receiving the contact method of the target user submitted by the first terminal, the server verifies the contact method, and returns the information collection page to the first terminal only when the verification succeeds. Before receiving the information collection page, the server performs the following step: receiving the contact method; verifying, based on the contact method, whether the target user satisfies a registration condition; and if yes, performing the operation of returning the information collection page to the first terminal; or if no, sending reminding information to the first terminal based on a verification failure type.

Specifically, in the process of verifying, based on the contact method, the server verifies whether the target user satisfies the registration condition, whether the contact method is registered and whether the contact method is marked in a black/gray list. If the target user does not satisfy the registration condition, a related reason is sent to the first terminal to improve the initiating user's perception of the verification result.

For example, the inviting user submits a contact method of an invited aged user by using the inviting terminal through the initial page shown in FIG. 3. After obtaining the contact method, the server queries a registration record table for whether a registration record of the contact method exists. If no, the server inputs the contact method to a trusted algorithm for trusted verification, and if a verification result output by the trusted algorithm is that the verification succeeds, returns the information collection page shown in FIG. 4 to the inviting terminal. It is worthwhile to note that, the inviting user can view an address book by triggering 301 and select a friend from the address book. The inviting terminal submits the contact method to the server when detecting that a “next” control is triggered. After the inviting terminal displays the information collection page in FIG. 4, the inviting user enters the name and identity of the aged user. The inviting terminal submits registration information of the aged user including the name and the identity to the server when detecting that a “conform” control is triggered.

In actual applications, inviting the target user to register an account implements a marketing effect through sharing, and a threshold problem of the target user still exists in the account registration process. Therefore, a success rate of inviting a special group is relatively low, and the initiating user cannot perceive a registration problem that the target user encounters in account registration and a specific reason, so that time needs to be consumed for repeated communication. In this embodiment, the initiating user fills in the registration information of the target user to complete account registration of the target user.

During specific implementation, in the process in which the initiating user fills in the registration information of the target user by using the information collection page, to improve registration efficiency and avoid a registration failure caused by a format of the registration information filled by the initiating user not satisfying a format condition, validity verification needs to be performed on the registration information of the target user filled by the initiating user. In an optional implementation provided in this embodiment, in a process of collecting the registration information, the first terminal performs the following steps: collecting the registration information entered on the information collection page; verifying whether a format of the registration information satisfies a format condition; and if yes, submitting the registration information when detecting that a confirm control configured on the information collection page is triggered; or if no, displaying a format reminder to remind the initiating user to which the first terminal belongs to re-enter the registration information.

Specifically, in the process in which the initiating user fills in the registration information, the first terminal detects whether the registration information entered by the user satisfies the format condition. If the registration information satisfies the format condition, the first terminal submits, to the server when detecting that the confirm control configured on the information collection page is triggered, the registration information entered by the initiating user. If the registration information does not satisfy the format condition, the first terminal displays the format reminder to remind the initiating user to re-enter the registration information based on the displayed format reminder.

After receiving the registration information, the server generates the invitation list based on the registration information entered based on the information collection page and submitted by the first terminal, and sends, based on the contact method, the invitation link generated based on the invitation list to the second terminal. The invitation list is generated based on the registration information and identity information of the initiating user, and the invitation list further includes an invitation state and a registration response result. The invitation state in the invitation list includes WAITING, PENDING, REGISTERING, SUCCESS, and/or FAIL. If the invitation state is “FAIL”, the registration failure cause is added to the registration response result.

During specific implementation, after receiving the registration information submitted by the first terminal, the server generates the invitation list based on the identity information of the initiating user and the registration information of the target user, and generates the invitation link based on the invitation list and sends the invitation link to the second terminal of the target user. In the process of sending the invitation link to the second terminal based on the contact method, the server performs the following steps: generating the invitation link based on the invitation list identifier of the invitation list; and sending, to the target user based on the contact method, a registration reminder including the invitation link, and sending, to the first terminal, a waiting reminder indicating that the registration reminder has been sent.

Specifically, after receiving the contact method submitted by the first terminal, the server reads, by using a user account associated with the first terminal, identity information that has an association relationship with the user account, creates the invitation list based on the identity information of the initiating user and the registration information of the target user, generates the invitation link based on the invitation list identifier, and sends the registration reminder including the invitation link to the second terminal based on the contact method. For example, the server queries, based on a user account of the inviting user associated with the inviting terminal, identity information that has an association relationship with the user account, and creates the invitation list shown in Table 1 based on the inviter account ID of the inviting user, and the registration information that includes the name and the identity of the aged user “user B” and that is submitted by the inviting user by using the inviting terminal through the information collection page shown in FIG. 4. In an early stage of creating the invitation list, the invitation state is “WAITING”, the invitation list ID is concatenated in an original invitation link to re-generate a short link, and the short link is sent to the aged user “user B” by using a message, etc. To enable the inviting user to perceive an invitation progress in time, after the short message is sent to the aged user “user B”, a waiting reminder page shown in FIG. 5 is sent to the inviting user, and the inviting user can send, to the aged user by using the waiting reminder, an invitation message including the short link.

TABLE 1

| | | | | | |
|---|---|---|---|---|---|
| | Inviter | Contact | Registration | Registration | |
| Invitation | account | method of | information of | response | Invitation |
| list ID | ID | the invitee | the invitee | result | state |

| | | | | |
|---|---|---|---|---|
| 20210301 | 2088001 | 135xxxx0000 | Name: User B; | WAITING |
| | | | identity: | |
| | | | 1000xxxx001 | |

As shown in FIG. 5, the waiting reminder page sent to the inviting user includes specific content of an invitation message sent to the aged user “user B”, and a “Send message again” control is configured. If the invitation link in the invitation message is not triggered by the aged user “user B” in a certain period of time, the “Send message again” control can be triggered to send the invitation message to the aged user “user B” again.

It is worthwhile to note that, after the invitation list is created, to enable the initiating user to view the invitation state in the invitation list at any time, the server sends, the first terminal of the initiating user, a viewing reminder that includes the invitation list identifier. Specifically, the initiating user views the invitation state in the following way: sending a viewing reminder of viewing the invitation list to the first terminal based on the invitation list identifier of the invitation list; and after the viewing reminder is triggered, querying the invitation state recorded in the invitation list, and sending the invitation state to the first terminal. In an optional implementation provided in this embodiment, an invitation list reminder that includes the invitation list identifier and that is sent by the server is received, and after the invitation list reminder is triggered, the invitation state recorded in the invitation list is obtained. After the initiating user submits an access request for the viewing reminder, the invitation state in the corresponding invitation list is viewed based on the invitation list identifier included in the access request, and the invitation state is sent to the initiating user.

Step S1204: Display, after the invitation link is triggered, a registration confirmation page generated based on display configuration information and registration information of a target user submitted by an initiating user.

After sending the invitation link to the second terminal, the server determines a display configuration parameter of the target user based on the registration information after the invitation link is triggered. The display configuration parameter includes a font, display text, etc., used on a display page when the registration information is displayed to the target user.

During specific implementation, after the target user triggers the invitation link, the server identifies a user characteristic type in the registration information, for example, aged peoples over 60 years old, to determine a displayed page style, and uses a large-character page to render guide text of interest to the aged peoples to enhance registration intentions of the aged people. In the process of determining the display configuration parameter of the target user based on the registration information after the invitation link is triggered, the server performs the following steps: after the invitation link is triggered, reading recorded content in the invitation list based on the invitation list identifier included in the invitation link; parsing an identity card identifier of the target user in the recorded content to obtain a user characteristic type of the target user; and inputting the user characteristic type to a parameter configuration algorithm to perform parameter configuration, to obtain the display configuration parameter.

Specifically, the server parses the identity card identifier of the target user to obtain the user characteristic type (for example, a first user characteristic and a second user characteristic) of the target user, and inputs the user characteristic type to the parameter configuration algorithm, and the parameter configuration algorithm determines, based on the user characteristic type, a display font and display text used in the process of displaying the registration information to the target user.

For example, after obtaining an access request that is for the invitation link and that is submitted by the aged user “user B”, the server queries information recorded in the corresponding invitation list based on the invitation list identifier in the invitation link, parses the found identity of the aged user to learn that the aged user “user B” is a male and 63 years old, and inputs the two user features, that is, “male” and “63 years old”, to the parameter configuration algorithm, to learn that a display font type output by the parameter configuration algorithm is a large font, and the guide text is “Register to view stock trends”.

During specific implementation, after obtaining the display configuration parameter output by the parameter configuration algorithm, the server renders the registration confirmation page based on the display configuration parameter and the recorded information in the invitation list, and displays the registration confirmation page by using the second terminal of the target user. After obtaining the display configuration parameter, the server performs the following steps: rendering, based on the display configuration parameter, the registration confirmation page that includes the registration information and an identity in identity information; and displaying the registration confirmation page by using the second terminal, where the identity information is identity information that is read based on account information of the first terminal and that has an association relationship with the account information.

It is worthwhile to note that, the registration confirmation page can be rendered by the server. Specifically, the server generates the registration confirmation page based on the obtained display configuration parameter, and sends the registration confirmation page to the second terminal, so that the second terminal displays the registration confirmation page. In addition, the second terminal can render the registration confirmation page. Specifically, after obtaining the display configuration parameter, the server sends the display configuration parameter and the recorded information to the second terminal, and the second terminal renders the registration confirmation page based on the display configuration parameter and the recorded information and displays the registration confirmation page.

As shown in FIG. 6, after obtaining the display configuration parameter determined based on the first user characteristic and the second user characteristic of the aged user “user B”, the server send, to the invited terminal of the aged user “user B”, the display configuration parameter, the name “user A” of the inviting user determined based on the inviter account ID, and the name, the contact method, and the identity of the aged user “user B”, and the invited terminal renders the registration confirmation page based on the previous information and displays the registration confirmation page. In addition, in an account registration process, an authorization instruction for a service privacy protocol needs to be obtained. To further simplify an operation procedure, an authorization reminder for the service privacy protocol is rendered on the registration confirmation page. After confirming that the name, the contact method, and the identity are correct, the aged user can submit a registration confirmation request by triggering a “Confirm, and direct register using the current phone number” control configured on the registration confirmation page. The registration confirmation page includes the name of user A, and includes the name, the mobile number, and the identity of the aged user “user B”. In addition, the guide text “Register to view stock trends” for the aged user “user B” is further rendered.

It is worthwhile to note that, after the target user accesses the invitation link, the server updates the invitation state in the invitation list to “PENDING”; and after the target user submits the registration confirmation instruction by using the registration confirmation page, the server updates the invitation state in the invitation list to “REGISTERING”, so that the initiating user can view the invitation state.

Step S1206: Submit a registration confirmation instruction to the server after a registration confirmation control configured on the registration confirmation page is triggered.

During specific implementation, if the server receives the registration confirmation instruction submitted after the second terminal displays the information based on the display configuration parameter, the server performs account registration based on the registration information, and sends the registration result to the first terminal. After obtaining the registration confirmation request submitted by the target user by using the registration confirmation page displayed by the second terminal, the server performs account registration based on the contact method and the registration information of the target user. The server performs account registration in the following way: generating an account identifier based on an account identifier generation algorithm; establishing an association relationship between the account identifier and each of the registration information and the contact method; and sending the account identifier to the target user by using the second terminal.

Specifically, the account identifier is generated by using the account identifier generation algorithm, and then the association relationship between the account identifier and each of the contact method and the registration information of the target user is established, so as to allocate the account identifier to the target user. In addition, in the account registration process, the contact method and the registration information of the target user can be further input to the account identifier generation algorithm obtain the account identifier that is output by the account identifier generation algorithm and that has an association relationship with the contact method and the registration information, and the account identifier is determined as an account identifier of the target user.

To improve perception of the initiating user for an invitation progress, after the target user succeeds in registration or fails in registration, the server updates the invitation list, and sends an updated registration result to the first terminal. After performing account registration, the server first updates the invitation state in the invitation list based on the registration result, and then sends the registration result to the first terminal based on the invitation state. If the registration result is “SUCCESS”, the registration result “SUCCESS” is updated to the invitation list; or if the registration result is “FAIL”, a registration failure cause is read, and the registration failure cause and the registration result “FAIL” are updated to the invitation list.

Specifically, if the registration succeeds, the invitation state in the invitation list is updated to “SUCCESS”, and a registration success reminder is sent to the first terminal, to guide the initiating user to add a user account of the target user as a friend or invite the target user to enable more services. If the registration fails, the invitation state in the invitation list is updated to “FAIL”, the registration response result is updated to a failure cause, and a registration failure reminder including the failure cause is sent to the first terminal, to guide the initiating user to attempt to perform invitation in another way. It is worthwhile to note that, when a registration result reminder is sent to the initiating user, the invitation list ID can be concatenated in an original notification link to re-generate a short link, and the registration result is sent to the initiating user through intra-station information, etc. If an access request of the initiating user for the short link is detected, the invitation state in the invitation list is queried based on the invitation ID in the access request, and the invitation state is displayed to the initiating user. In an optional implementation provided in this specification, if a registration result of performing account registration based on the registration information after the server receives the registration confirmation instruction is “SUCCESS”, an account identifier sent by the server is received and displayed.

As shown in FIG. 2, when the initiating user invites the target user to perform account registration, the initiating user submits the contact method of the target user to the server by using the first terminal; the server verifies whether the contact method satisfies the registration invitation condition, and if no, sends the reminding information to the first terminal based on the verification failure type, or if yes, returns the information collection page to the first terminal; the first terminal submits the registration information of the target user to the server by using the information collection page; the server creates the invitation list based on the registration information, and creates the invitation link based on the invitation list identifier of the invitation list, and sends the invitation link to the second terminal of the target user; the server reads the recorded information in the invitation list based on the invitation list identifier when detecting that the invitation link is triggered; the server parses the identity card identifier in the recorded information to obtain the user characteristic type of the target user; the server inputs the user characteristic type to the parameter configuration algorithm to perform parameter configuration, to obtain the display configuration parameter for the target user; the server renders an information display page based on the display configuration parameter and the recorded information; the server sends the information display page to the second terminal, so that the second terminal displays the information display page to the target user; and the server obtains the registration confirmation reminder that is of the target user for the recorded information and that is submitted by the second terminal, performs account registration based on the registration confirmation reminder, and sends the registration result to the first terminal, so that the first terminal displays the registration result to the initiating user.

The following describes a registration processing procedure provided in an embodiment.

FIG. 13 is a processing flowchart illustrating a registration processing procedure, which specifically includes the following step S1302 to step S1312. It is worthwhile to note that, the registration processing procedure provided in this embodiment cooperates with the previously described registration processing procedure applied to the server in an execution process.

Step S1302: Receive an invitation link that is generated based on an invitation list identifier and that is sent by a server.

Step S1304: Submit an access request for the invitation link to the server after it is detected that the invitation link is triggered.

Step S1306: Receive a display configuration parameter and recorded information sent by the server.

Step S1308: Render, based on the display configuration parameter, a registration confirmation page that includes the recorded information, and displays the registration confirmation page.

Step S1310: Submit a registration confirmation instruction to the server after it is detected that a confirm control on the registration confirmation page is triggered.

Step S1312: Receive a user account that is sent by the server and that has an association relationship with a contact method and registration information of an aged user.

The account registration processing method provided in this embodiment is further described by using an example in which the account registration processing method provided in this embodiment is applied to a registration invitation scenario. Referring to FIG. 9, the account registration processing method applied to the registration invitation scenario includes the following steps.

Step S912: A second terminal submits an access request for an invitation link to a server. Before this, a first terminal submits a contact method of an aged user to the server; the first terminal receives an information collection page returned by the server; the first terminal submits registration information of the aged user to the server based on an information collection page; the server creates an invitation list based on the registration information of the aged user and an identity of an inviting user; and the server generates an invitation link based on an invitation list identifier of the invitation list, sends the invitation link to the second terminal, and sends a waiting reminder to the first terminal after sending the invitation link to the second terminal.

Afterwards, the server reads recorded information in the invitation list based on the invitation list identifier included in the access request, parses an identity card identifier of the aged user, and determines a display configuration parameter based on a user characteristic type obtained through parsing; and sends, to the second terminal, the display configuration parameter and the registration information of the aged user and the identity of the inviting user in the recorded information.

Step S920: The second terminal renders, based on the display configuration parameter, a registration confirmation page that includes the registration information and the identity, and displays the registration confirmation page.

Step S922: The second terminal submits a registration confirmation instruction for the registration information to the server.

Afterwards, the server performs account registration based on the registration confirmation instruction, and sends a registration result to the first terminal.

In conclusion, in the account registration processing method provided in this embodiment; the invitation link sent by the server is first received; and then, after the invitation link is triggered, the registration confirmation page generated based on the display configuration information and the registration information of the target user submitted by the initiating user is displayed; and finally, the registration confirmation instruction is submitted to the server after the registration confirmation control configured on the registration confirmation page is triggered. As such, the target user can perform account registration only by submitting the registration confirmation instruction, thereby improving simplicity of account registration.

One or more embodiments of a first account registration processing apparatus provided in this specification are as follows. In the previous embodiments, the account registration processing method applied to a server is provided. Correspondingly, an account registration processing apparatus is further provided and runs on the server, which is described below reference to the accompanying drawings.

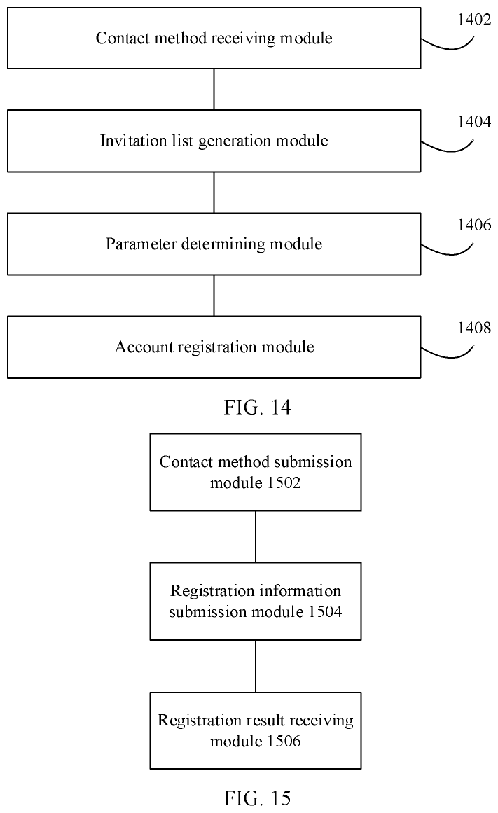

FIG. 14 is a schematic diagram illustrating an account registration processing apparatus, according to one or more embodiments.

The apparatus embodiment corresponds to the method embodiment, and therefore is described briefly. For related parts, references can be made to the corresponding description of the method embodiment provided above. The apparatus embodiment described below is merely an example.

One or more embodiments provide an account registration processing apparatus, which runs on a server and includes: a contact method receiving module 1402, configured to receive a contact method of a target user submitted by a first terminal, and return an information collection page to the first terminal; an invitation list generation module 1404, configured to generate an invitation list based on registration information entered based on the information collection page and submitted by the first terminal, and send, based on the contact method, an invitation link generated based on the invitation list to a second terminal; a parameter determining module 1406, configured to determine a display configuration parameter of the target user based on the registration information after the invitation link is triggered; and an account registration module 1408, configured to perform account registration based on the registration information and send a registration result to the first terminal if a registration confirmation instruction submitted after the second terminal displays information based on the display configuration parameter is received.

One or more embodiments of a second account registration processing apparatus provided in this specification are as follows. In the previous embodiments, the account registration processing method applied to a first terminal is provided. Correspondingly, an account registration processing apparatus is further provided and runs on the first terminal, which is described below reference to the accompanying drawings.

FIG. 15 is a schematic diagram illustrating an account registration processing apparatus, according to one or more embodiments.

The apparatus embodiment corresponds to the method embodiment, and therefore is described briefly. For related parts, references can be made to the corresponding description of the method embodiment provided above. The apparatus embodiment described below is merely an example.

One or more embodiments provide an account registration processing apparatus, which runs on a first terminal and includes: a contact method submission module 1502, configured to submit a contact method of a target user to a server by using an initial page, and receive an information collection page returned by the server; a registration information submission module 1504, configured to enter registration information of the target user by using the information collection page, and submit the registration information to the server; and a registration result receiving module 1506, configured to receive a registration result returned after the server performs registration processing based on the registration information.

One or more embodiments of a third account registration processing apparatus provided in this specification are as follows. In the previous embodiments, the account registration processing method applied to a second terminal is provided. Correspondingly, an account registration processing apparatus is further provided and runs on the second terminal, which is described below reference to the accompanying drawings.

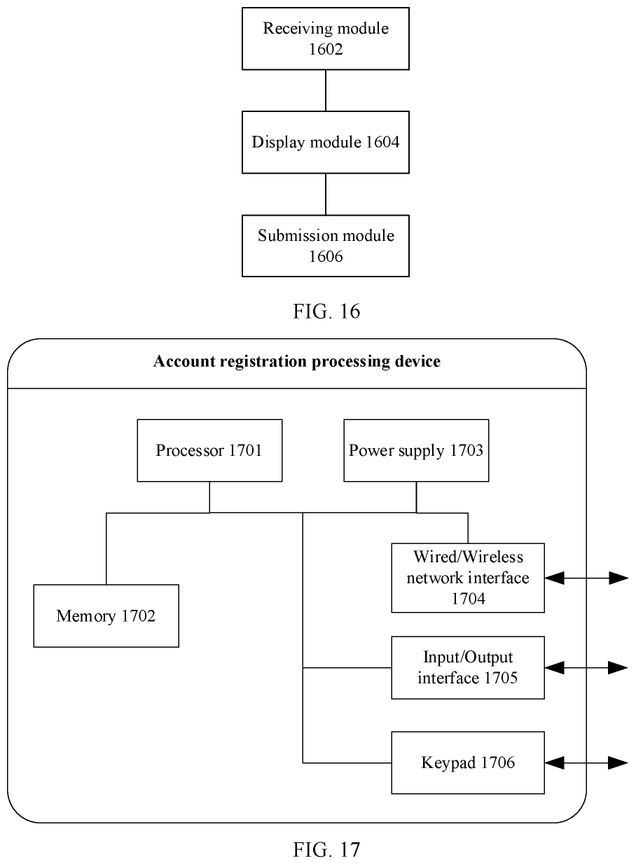

FIG. 16 is a schematic diagram illustrating an account registration processing apparatus, according to one or more embodiments.

The apparatus embodiment corresponds to the method embodiment, and therefore is described briefly. For related parts, references can be made to the corresponding description of the method embodiment provided above. The apparatus embodiment described below is merely an example.

One or more embodiments provide an account registration processing apparatus, which runs on a second terminal and includes: a receiving module 1602, configured to receive an invitation link sent by a server; a display module 1604, configured to display, after the invitation link is triggered, a registration confirmation page generated based on display configuration information and registration information of a target user submitted by an initiating user; and a submission module 1606, configured to submit a registration confirmation instruction to the server after a registration confirmation control configured on the registration confirmation page is triggered.

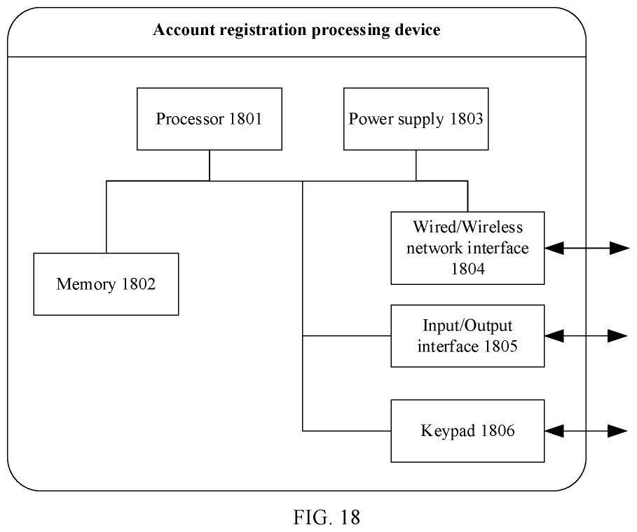

One or more embodiments of a first account registration processing device provided in this specification are as follows. Corresponding to the previously described account registration processing method applied to a server, based on the same technical concept, one or more embodiments of this specification further provide an account registration processing device running on the server. The account registration processing device is configured to perform the account registration processing method provided above. FIG. 17 is a schematic diagram illustrating a structure of a first account registration processing device, according to one or more embodiments of this specification.

The account registration processing device provided in the one or more embodiments runs on a server and includes: as shown in FIG. 17, the account registration processing device may vary greatly due to different configurations or performance, and can include one or more processors 1701 and a memory 1702. The memory 1702 can store one or more storage applications or data. The memory 1702 can be a temporary storage or persistent storage. The application stored in the memory 1702 can include one or more modules (not shown in the figure), and each module can include a series of computer-executable instructions in the account registration processing device. Further, the processor 1701 can be configured to communicate with the memory 1702, and execute the series of computer-executable instructions in the memory 1702 on the account registration processing device. The account registration processing device can further include one or more power supplies 1703, one or more wired or wireless network interfaces 1704, one or more input/output interfaces 1705, one or more keypads 1706, etc.

In a specific embodiment, the account registration processing device includes a memory and one or more programs. The one or more programs are stored in the memory. The one or more programs can include one or more modules, and each module can include a series of computer-executable instructions in the account registration processing device. Through configuration, one or more processors execute the following computer-executable instructions included in the one or more programs: receiving a contact method of a target user submitted by a first terminal, and returning an information collection page to the first terminal; generating an invitation list based on registration information entered based on the information collection page and submitted by the first terminal, and sending, based on the contact method, an invitation link generated based on the invitation list to a second terminal; determining a display configuration parameter of the target user based on the registration information after the invitation link is triggered; and performing account registration based on the registration information and sending a registration result to the first terminal if a registration confirmation instruction submitted after the second terminal displays information based on the display configuration parameter is received.

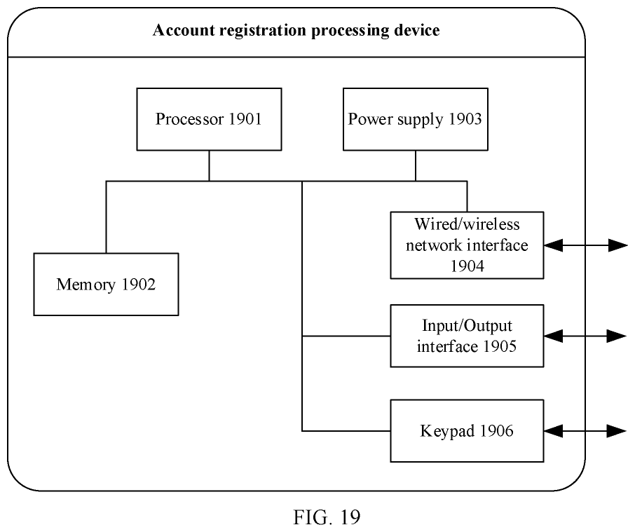

One or more embodiments of a second account registration processing device provided in this specification are as follows. Corresponding to the previously described account registration processing method applied to a first terminal, based on the same technical concept, one or more embodiments of this specification further provide an account registration processing device running on the first terminal. The account registration processing device is configured to perform the account registration processing method provided above. FIG. 18 is a schematic diagram illustrating a structure of a second account registration processing device, according to one or more embodiments of this specification.

The account registration processing device provided in the one or more embodiments runs on a first terminal and includes: As shown in FIG. 18, the account registration processing device may vary greatly due to different configurations or performance, and can include one or more processors 1801 and a memory 1802. The memory 1802 can store one or more storage applications or data. The memory 1802 can be a temporary storage or persistent storage. The application stored in the memory 1802 can include one or more modules (not shown in the figure), and each module can include a series of computer-executable instructions in the account registration processing device. Further, the processor 1801 can be configured to communicate with the memory 1802, and execute the series of computer-executable instructions in the memory 1802 on the account registration processing device. The account registration processing device can further include one or more power supplies 1803, one or more wired or wireless network interfaces 1804, one or more input/output interfaces 1805, one or more keypads 1806, etc.

In a specific embodiment, the account registration processing device includes a memory and one or more programs. The one or more programs are stored in the memory. The one or more programs can include one or more modules, and each module can include a series of computer-executable instructions in the account registration processing device. Through configuration, one or more processors execute the following computer-executable instructions included in the one or more programs: submitting a contact method of a target user to a server by using an initial page, and receiving an information collection page returned by the server; entering registration information of the target user by using the information collection page, and submitting the registration information to the server; and receiving a registration result returned after the server performs registration processing based on the registration information.

One or more embodiments of a third account registration processing device provided in this specification are as follows. Corresponding to the previously described account registration processing method applied to a second terminal, based on the same technical concept, one or more embodiments of this specification further provide an account registration processing device running on the second terminal. The account registration processing device is configured to perform the account registration processing method provided above. FIG. 19 is a schematic diagram illustrating a structure of a third account registration processing device, according to one or more embodiments of this specification.

The account registration processing device provided in the one or more embodiments runs on a second terminal and includes: As shown in FIG. 19, the account registration processing device may vary greatly due to different configurations or performance, and can include one or more processors 1901 and a memory 1902. The memory 1902 can store one or more storage applications or data. The memory 1902 can be a temporary storage or persistent storage. The application stored in the memory 1902 can include one or more modules (not shown in the figure), and each module can include a series of computer-executable instructions in the account registration processing device. Further, the processor 1901 can be configured to communicate with the memory 1902, and execute the series of computer-executable instructions in the memory 1902 on the account registration processing device. The account registration processing device can further include one or more power supplies 1903, one or more wired or wireless network interfaces 1904, one or more input/output interfaces 1905, one or more keypads 1906, etc.

In a specific embodiment, the account registration processing device includes a memory and one or more programs. The one or more programs are stored in the memory. The one or more programs can include one or more modules, and each module can include a series of computer-executable instructions in the account registration processing device. Through configuration, one or more processors execute the following computer-executable instructions included in the one or more programs: receiving an invitation link sent by a server; displaying, after the invitation link is triggered, a registration confirmation page generated based on display configuration information and registration information of a target user submitted by an initiating user; and submitting a registration confirmation instruction to the server after a registration confirmation control configured on the registration confirmation page is triggered.

One or more embodiments of a first storage medium provided in this specification are as follows. Corresponding to the previously described account registration processing method applied to a server, based on the same technical concept, one or more embodiments of this specification further provide a storage medium.

The storage medium provided in the one or more embodiments is configured to store computer-executable instructions. When the computer-executable instructions are executed, the following procedure is implemented: receiving a contact method of a target user submitted by a first terminal, and returning an information collection page to the first terminal; generating an invitation list based on registration information entered based on the information collection page and submitted by the first terminal, and sending, based on the contact method, an invitation link generated based on the invitation list to a second terminal; determining a display configuration parameter of the target user based on the registration information after the invitation link is triggered; and performing account registration based on the registration information and sending a registration result to the first terminal if a registration confirmation instruction submitted after the second terminal displays information based on the display configuration parameter is received.

It is worthwhile to note that the embodiments of the storage medium in this specification and the embodiments of the account registration processing method in this specification are based on the same invention concept. Therefore, for specific implementation of the embodiments, references can be made to the implementation of the previous corresponding method, and details are omitted here for simplicity.

One or more embodiments of a second storage medium provided in this specification are as follows. Corresponding to the previously described account registration processing method applied to a first terminal, based on the same technical concept, one or more embodiments of this specification further provide a storage medium.

The storage medium provided in the one or more embodiments is configured to store computer-executable instructions. When the computer-executable instructions are executed, the following procedure is implemented: submitting a contact method of a target user to a server by using an initial page, and receiving an information collection page returned by the server; entering registration information of the target user by using the information collection page, and submitting the registration information to the server; and receiving a registration result returned after the server performs registration processing based on the registration information.

It is worthwhile to note that the embodiments of the storage medium in this specification and the embodiments of the account registration processing method in this specification are based on the same invention concept. Therefore, for specific implementation of the embodiments, references can be made to the implementation of the previous corresponding method, and details are omitted here for simplicity.

One or more embodiments of a third storage medium provided in this specification are as follows. Corresponding to the previously described account registration processing method applied to a second terminal, based on the same technical concept, one or more embodiments of this specification further provide a storage medium.

The storage medium provided in the one or more embodiments is configured to store computer-executable instructions. When the computer-executable instructions are executed, the following procedure is implemented: receiving an invitation link sent by a server; displaying, after the invitation link is triggered, a registration confirmation page generated based on display configuration information and registration information of a target user submitted by an initiating user; and submitting a registration confirmation instruction to the server after a registration confirmation control configured on the registration confirmation page is triggered.

It is worthwhile to note that the embodiments of the storage medium in this specification and the embodiments of the account registration processing method in this specification are based on the same invention concept. Therefore, for specific implementation of the embodiments, references can be made to the implementation of the previous corresponding method, and details are omitted here for simplicity.

Specific embodiments of this specification are described above. Other embodiments fall within the scope of the appended claims. In some cases, the actions or steps described in the claims can be performed in an order different from that in the embodiments, and the desired results can still be achieved. In addition, the processes depicted in the accompanying drawings do not necessarily need a particular order or consecutive order to achieve the desired results. In some implementations, multi-tasking and parallel processing are feasible or may be advantageous.

In the 1930s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit to obtain a corresponding hardware circuit structure. Therefore, a method procedure can be improved using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application-specific integrated circuit chip. In addition, at present, instead of manually manufacturing an integrated circuit chip, this type of programming is mostly implemented by using “logic compiler” software. The programming is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using some described hardware description languages and is programmed into an integrated circuit.

A controller can be implemented by using any appropriate method. For example, the controller can be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. A person skilled in the art also knows that, in addition to implementing the controller by using only the computer-readable program code, logic programming can be performed on method steps to enable the controller to implement the same function in forms of the logic gate, the switch, the application-specific integrated circuit, the programmable logic controller, the embedded microcontroller, etc. Therefore, the controller can be considered as a hardware component, and an apparatus configured to implement various functions in the controller can also be considered as a structure in the hardware component. Alternatively, the apparatus configured to implement various functions can even be considered as both a software module implementing the method and a structure in the hardware component.

The system, apparatus, module, or unit illustrated in the previous embodiments can be specifically implemented by using a computer chip or an entity, or can be implemented by using a product having a certain function. A typical implementation device is a computer. Specifically, for example, the computer can be a personal computer, a laptop computer, a cellular phone, a camera phone, a smart phone, a personal digital assistant, a media player, a navigation device, an e-mail device, a game console, a tablet computer, a wearable device, or any combination of these devices.

For ease of description, the above-mentioned apparatus is described by dividing functions into various units. Certainly, when the embodiments of this specification are implemented, functions of the units can be implemented in one or more pieces of software and/or hardware.

A person skilled in the art should understand that one or more embodiments of this specification can be provided as a method, a system, or a computer program product. Therefore, the one or more embodiments of this specification can use a form of hardware only embodiments, software only embodiments, or embodiments with a combination of software and hardware. In addition, this specification can use a form of a computer program product that is implemented on one or more computer-usable storage media (including but not limited to a disk memory, a CD-ROM, an optical memory, etc.) that include computer-usable program code.

This specification is described with reference to the flowcharts and/or block diagrams of the method, the device (system), and the computer program product according to the embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more procedures in the flowcharts and/or in one or more blocks in the block diagrams.

These computer program instructions can alternatively be stored in a computer-readable memory that can instruct the computer or the another programmable data processing device to work in a specific way, so the instructions stored in the computer-readable memory generate an artifact that includes an instruction apparatus. The instruction apparatus implements a specific function in one or more procedures in the flowcharts and/or in one or more blocks in the block diagrams.

These computer program instructions can alternatively be loaded onto the computer or another programmable data processing device, so a series of operations and steps are performed on the computer or the another programmable device, thereby generating computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPU), an input/output interface, a network interface, and a memory.

The memory can include a non-persistent memory, a random access memory (RAM), a non-volatile memory, and/or another form in a computer-readable medium, for example, a read-only memory (ROM) or a flash memory (flash RAM). The memory is an example of the computer-readable medium.

The computer-readable medium includes persistent, non-persistent, movable, and unmovable media that can store information by using any method or technology. The information can be a computer-readable instruction, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be used to store information accessible by a computing device. As described in this specification, the computer-readable medium does not include computer-readable transitory media such as a modulated data signal and a carrier.

It should be further noted that, the terms “include”, “comprise”, or any other variant thereof are intended to cover a non-exclusive inclusion, so a process, a method, a product or a device that includes a list of elements not only includes those elements but also includes other elements that are not expressly listed, or further includes elements inherent to such a process, method, product, or device. Without more constraints, an element preceded by “includes a . . . ” does not preclude the existence of additional identical elements in the process, method, product, or device that includes the element.

The one or more embodiments of this specification can be described in the general context of computer-executable instructions executed by a computer, for example, a program module. Generally, the program module includes a routine, a program, an object, a component, a data structure, etc. executing a specific task or implementing a specific abstract data type. The one or more embodiments of this specification can also be practiced in distributed computing environments. In the distributed computing environments, tasks are performed by remote processing devices that are connected through a communication network. In the distributed computing environments, the program module can be located in a local and remote computer storage medium including a storage device.

The embodiments of this specification are described in a progressive way. For the same or similar parts of the embodiments, references can be made to the embodiments. Each embodiment focuses on a difference from other embodiments. Particularly, a system embodiment is basically similar to a method embodiment, and therefore is described briefly. For related parts, references can be made to partial descriptions in the method embodiment.

The previous descriptions are merely embodiments of this specification and are not intended to limit this specification. A person skilled in the art can make various modifications and changes to this specification. Any modification, equivalent replacement, or improvement made without departing from the spirit and principle of this specification shall fall within the scope of the claims of this specification.

1. An account registration processing method, applied to a server, comprising:
receiving a contact method of a target user submitted by a first terminal, and returning an information collection page to the first terminal;
generating an invitation list based on registration information entered based on the information collection page and submitted by the first terminal, and sending, based on the contact method, an invitation link generated based on the invitation list to a second terminal;
determining a display configuration parameter of the target user based on the registration information after the invitation link is triggered; and
performing account registration based on the registration information and sending a registration result to the first terminal upon determining that a registration confirmation instruction submitted after the second terminal displays information based on the display configuration parameter is received.

2. The account registration processing method according to claim 1, wherein the receiving a contact method of a target user submitted by a first terminal, and returning an information collection page to the first terminal comprises:
receiving the contact method, and verifying, based on the contact method, whether the target user satisfies a registration condition; and
upon determining that the target user satisfies the registration condition if yes, performing the operation of returning the information collection page to the first terminal; or
upon determining that the target user does not satisfy the registration condition if no, sending reminding information to the first terminal based on a verification failure type.

3. The account registration processing method according to claim 1, wherein the sending, based on the contact method, an invitation link generated based on the invitation list to a second terminal comprises:
generating the invitation link based on an invitation list identifier of the invitation list; and
sending, to the target user based on the contact method, a registration reminder comprising the invitation link, and sending, to the first terminal, a waiting reminder indicating that the registration reminder has been sent.

4. The account registration processing method according to claim 1, wherein the determining a display configuration parameter of the target user based on the registration information after the invitation link is triggered comprises:
after the invitation link is triggered, reading recorded content in the invitation list based on an invitation list identifier comprised in the invitation link;
parsing an identity card identifier of the target user in the recorded content to obtain a user characteristic type of the target user; and
inputting the user characteristic type to a parameter configuration algorithm to perform parameter configuration, to obtain the display configuration parameter.

5. The account registration processing method according to claim 1, after the step of determining a display configuration parameter of the target user based on the registration information after the invitation link is triggered is performed, and before the step of performing account registration based on the registration information and sending a registration result to the first terminal upon determining that a registration confirmation instruction submitted after the second terminal displays information based on the display configuration parameter is received is performed, further comprising:
rendering, based on the display configuration parameter, a registration confirmation page that comprises the registration information and an identity in identity information; and
displaying the registration confirmation page by using the second terminal, wherein
the identity information is identity information that is read based on account information of the first terminal and that has an association relationship with the account information.

6. The account registration processing method according to claim 1, wherein the performing account registration based on the registration information comprises:
generating an account identifier based on an account identifier generation algorithm;
establishing an association relationship between the account identifier and each of the registration information and the contact method; and
sending the account identifier to the target user by using the second terminal.

7. The account registration processing method according to claim 1, further comprising:
sending a viewing reminder of viewing the invitation list to the first terminal based on an invitation list identifier of the invitation list; and
after the viewing reminder is triggered, querying an invitation state recorded in the invitation list, and sending the invitation state to the first terminal.

8. The account registration processing method according to claim 1, wherein before submitting the registration information, the first terminal performs the following steps:
collecting the registration information entered to the information collection page;
verifying whether a format of the registration information satisfies a format condition; and
upon determining that the format of the registration information satisfies the format condition, submitting the registration information when detecting that a confirm control configured on the information collection page is triggered; or
upon determining that the format of the registration information does not satisfy the format condition, displaying a format reminder to remind an initiating user to which the first terminal belongs to re-enter the registration information.

9. The account registration processing method according to claim 1, wherein the sending a registration result to the first terminal comprises:
updating an invitation state in the invitation list based on the registration result;
sending the registration result to the first terminal based on the invitation state; and
upon determining that the registration result is “SUCCESS”, updating the registration result “SUCCESS” to the invitation list; or upon determining that the registration result is “FAIL”, reading a registration failure cause, and updating the registration failure cause and the registration result “FAIL” to the invitation list.

10. (canceled)

11. (canceled)

12. (canceled)

13. (canceled)

14. (canceled)

15. (canceled)

16. (canceled)

17. (canceled)

18. (canceled)

19. (canceled)

20. A computing device comprising a memory and a processor, wherein the memory stores executable instructions that, in response to execution by the processor, cause the processor to:
receive a contact method of a target user submitted by a first terminal, and return an information collection page to the first terminal;
generate an invitation list based on registration information entered based on the information collection page and submitted by the first terminal, and send, based on the contact method, an invitation link generated based on the invitation list to a second terminal;
determine a display configuration parameter of the target user based on the registration information after the invitation link is triggered; and
perform account registration based on the registration information and send a registration result to the first terminal upon determining that a registration confirmation instruction submitted after the second terminal displays information based on the display configuration parameter is received.

21. (canceled)

22. (canceled)

23. A non-transitory computer-readable storage medium comprising instructions stored therein that, when executed by a processor of a computing device, cause the processor to:
receive a contact method of a target user submitted by a first terminal, and return an information collection page to the first terminal;
generate an invitation list based on registration information entered based on the information collection page and submitted by the first terminal, and send, based on the contact method, an invitation link generated based on the invitation list to a second terminal;
determine a display configuration parameter of the target user based on the registration information after the invitation link is triggered; and
perform account registration based on the registration information and send a registration result to the first terminal upon determining that a registration confirmation instruction submitted after the second terminal displays information based on the display configuration parameter is received.

24. (canceled)

25. (canceled)
